(19) United States
(12) Patent Application Publication
(10) Pub. No.: US 2013/0031216 A1
(43) Pub. Date: Jan. 31, 2013

(54) SYSTEMS AND METHODS FOR GENERATION OF CUSTOMIZED MEDIA PLAYLISTS

(71) Applicants: Myk Willis, Sanibel, FL (US); David Pope, Coral Springs, FL (US); John Collette, Hollywood, FL (US); Scott Clark, Deerfield Beach, FL (US)

(72) Inventors: Myk Willis, Sanibel, FL (US); David Pope, Coral Springs, FL (US); John Collette, Hollywood, FL (US); Scott Clark, Deerfield Beach, FL (US)

(73) Assignee: Myxer, Inc.

(21) Appl. No.: 13/560,895

(22) Filed: Jul. 27, 2012

Related U.S. Application Data
(60) Provisional application No. 61/513,411, filed on Jul. 29, 2011.

(51) Int. Cl. G06F 15/16

(52) U.S. Cl. 709/219

(57) ABSTRACT

The present application is directed to methods and systems for providing social interaction within a customized media streaming service. In one aspect, the present application is directed to methods and systems for automated playlist generation based on social metadata. These systems allow for an internet media delivery service to learn about a listener's preferences, and changes in those preferences over time, without the listener being required to tell the service directly, but rather through social networking profiles and relationships to one or more similar or related users. This allows the service to immediately, without any input from the listener, play programming that is likely to be enjoyed by the listener. It also allows the service to learn about changes in a listener's preferences over time without requiring the user to actively express the preferences.

### RELATED APPLICATIONS

The present application claims priority to and the benefit of U.S. Provisional Patent Application No. 61/513,411, entitled “Systems and Methods for Social Network Integrated Customized Media Delivery,” filed Jul. 29, 2011, the entirety of which is hereby incorporated by reference.

### FIELD OF THE INVENTION

The methods and systems described herein relate generally to customized media delivery. In particular, the methods and systems described herein relate to customized media delivery including integration with social networking and group interaction.

### BACKGROUND OF THE INVENTION

Internet radio brought customized streaming media programming to users, providing the ability to make a personal virtual radio station. This technology, pioneered by companies such as Pandora Media, Inc., of Oakland, Calif., allowed listeners to provide a seed, in the form of an artist, song, or genre, and generate a customized playlist based off the seed. During playback of music, the listener could rate a song up or down, allowing similar songs to be added to or removed from the customized playlist. Over time, as more and more ratings were incorporated, the playlists would reflect the listener's preferences. However, these systems require manual effort by the listener to set up an initial profile of preferences, and then they require feedback from the listener over time to refine (or change) the preferences used in programming music. The listener therefore needs to actively manage their internet radio service to get good results.

Furthermore, while conventional broadcast radio and even non-customized internet multicasting stations could reach hundreds of thousands of listeners simultaneously, customized media streams were unicast to individual listeners' devices. In an effort to provide some social interaction capabilities, service providers added the ability to share playlist seeds. For example, through the social networking site Facebook, provided by Facebook, Inc. of Menlo Park, Calif., users of Pandora could “share” stations. Similar capabilities were available to users of Grooveshark, provided by Escape Media Group, Inc. of Gainesville, Fla., via the social networking site Twitter, by Twitter, Inc. of San Francisco, Calif. However, rather than actually sharing a station, users were merely sharing a current snapshot of a playlist or merely a seed reflecting the current state of a playlist. Those with whom the station was “shared” would essentially create their own, identical stations, based on the seed or playlist. Subsequent modifications to the original playlist by the original user would not be reflected in these copies, and modifications to the individual playlists of the “sharing” users would not be reflected in the original playlist or any other “shared” playlist. Thus, real time social interaction was not possible, even as the remainder of the social networking sphere moved in this direction.

### SUMMARY OF THE INVENTION

The present application is directed to methods and systems for providing social interaction within a customized media streaming service. In one aspect, the present application is directed to methods and systems for automated playlist generation based on social metadata. These systems allow for an internet media delivery service to learn about a listener's preferences, and changes in those preferences over time, without the listener being required to tell the service directly, but rather through social networking profiles and relationships to one or more similar or related users. This allows the service to immediately, without any input from the listener, play programming that is likely to be enjoyed by the listener. It also allows the service to learn about changes in a listener's preferences over time without requiring the user to actively express the preferences.

These systems take advantage of the fact that it is now common for people to maintain profiles on social networks such as MySpace, Facebook, Myxer, and many others which contain information about their interests, hobbies, and specifically their musical and artist preferences. The information is presented in many different forms, and may include simple lists of favorite artists/musical genres, links to web pages that feature particular artists/genres, widgets that feature particular artists or genres, or plaintext comments or other descriptions that express a like or dislike of particular forms of music. These profiles may be manually edited by users, when, for example, a user crafts a specific profile section describing their “favorite musical artists”. In other embodiments, they may be automatically created by a service such as a social network. An example of an automatically-created profile is a user profile on the website Myxer.com. Each user has a profile page that is created and accessible via a web browser that contains, among other things, a list of recently downloaded ringtones, MP3s, and other digital content for a user. These recently downloaded files may be considered media that the user has a positive preference for or “likes”. Another example is on Facebook, where if a user expresses a preference for a particular musical genre or artist through an online action (such as pressing a ‘like’ button provided by the Facebook API), information about that preference may be automatically made visible in their Facebook profile, regardless of where on the web the user expressed that preference.

In one embodiment of this invention, a user of an internet media delivery service provides account information for a social network profile that they have created, or that has been created for them by a social networking service. For example, the user may be prompted to ‘sign in’ to the media deliver service using a public authentication API provided by a social network, such as the Facebook Connect API. This provides access to the social network profile to the media delivery service, which may parse or scan the profile to retrieve and determine traits of the user and/or relationships between the user and other users.

Even in cases where a user's social networking profile contains no directly-applicable preference information that can help make programming decisions for their music, it is possible to intelligently program music for them based on the profiles of other people in their social graph. In general, users of social networks are connected to other users through “links” intended to mimic the real-world connections between them. For example, it is common for users to have links to their friends, co-workers, and family members, and it is uncommon for links to exist between people who have no such relationship.

The systems discussed herein examine the set of users who are linked to the listener, and determine which related or linked user or users are likely to share some or all musical preferences with the listener. Several heuristics are used to make this determination. The heaviest weight is given to factors which have experimentally been shown to correlate with musical preferences. The weights may be dynamically adjusted over time as more data is received by the system regarding correlations between media preferences and user traits. For example, the service can examine the profiles or two listeners who are known to have similar musical preferences. Factors in each user's profile that are similar are given a slight ‘boost’ in weight with regard to musical preferences.

In one aspect, the present application is directed to a method for media selection based on social metadata. The method includes receiving, by a media server from a device of a first user, a request for a first item of media. The method also includes retrieving, by the media server from a social network server, social metadata of the first user, the social metadata identifying at least one artist. The method further includes requesting, by the media server from a recommendation server, a media list based on the identified at least one artist. The method also includes receiving, by the media server, the requested media list. The method further includes selecting, by the media server, the first item of media from the modified media list, and transmitting, by the media server to the device for presentation to the first user, an identification of the selected first item of media.

In one embodiment of the method, the request for a first item of media does not identify the at least one artist. In another embodiment, the method includes presenting to the first user a list of artists comprising the identified at least one artist; and receiving a selection by the first user of the at least one artist. In yet another embodiment, the social metadata comprises identifications of one or more artists the user has rated positively. In another embodiment, the social metadata comprises identifications of one or more artists on which the user has commented.

In some embodiments, the method includes requesting the media list based on one or more items of media rated by the first user. In other embodiments, the method includes receiving a request of the first user to join a group receiving a customized media playlist; and requesting the media list based on the customized media playlist associated with the group. In a further embodiment of the method, the customized media playlist associated with the group comprises a media list based on one or more artists identified by a user of the group and social metadata of each user of the group. In another further embodiment, the method includes modifying the customized media playlist associated with the group to remove one or more items of media responsive to negative ratings of the one or more items of media by the first user. In yet another further embodiment, the method includes identifying, by the media server, that a second user of the group has left the group; and requesting, by the media server from the recommendation server, a second media list based on the media list and social metadata of the remaining users of the group.

In another aspect, the present disclosure is directed to a system for media selection based on social metadata. The system includes a first device comprising a media server, in communication with a device of a first user. The first device is configured for receiving, from the device of the first user, a request for a first item of media; and retrieving, from a social network server, social metadata of the first user, the social metadata identifying at least one artist. The first device is also configured for requesting, from a recommendation server, a media list based on the identified at least one artist; receiving the requested media list; selecting the first item of media from the modified media list; and transmitting, to the device of the first user, an identification of the selected first item of media.

In one embodiment of the system, the request for a first item of media does not identify the at least one artist. In another embodiment of the system, the first device is further configured for presenting to the first user a list of artists comprising the identified at least one artist; and receiving a selection by the first user of the at least one artist. In another embodiment of the system, the social metadata comprises identifications of one or more artists the user has rated positively. In yet another embodiment of the system, the social metadata comprises identifications of one or more artists the user has commented on.

In some embodiments of the system, the first device is further configured for requesting the media list based on one or more items of media rated by the first user. In other embodiments of the system, the first device is further configured for receiving a request of the first user to join a group receiving a customized media playlist; and requesting the media list based on the customized media playlist associated with the group. In a further embodiment, the customized media playlist associated with the group comprises a media list based on one or more artists identified by a user of the group and social metadata of each user of the group. In another further embodiment, the first device is further configured for modifying the customized media playlist associated with the group to remove one or more items of media responsive to negative ratings of the one or more items of media by the first user. In still another further embodiment, the first device is further configured for identifying that a second user of the group has left the group; and requesting, from the recommendation server, a second media list based on the media list and social metadata of the remaining users of the group.

In yet another aspect, the present application is directed to a method for generating customized media playlists. The method includes receiving, by a media server from a device of a first user, a request to generate a customized media playlist, the request including an identification of a first seed artist; and requesting, by the media server from a recommendation server, a first media list of media of the first seed artist. The method also includes requesting, by the media server from the recommendation server, a second media list of media compatible with the first seed artist. The method further includes requesting, by the media server from the recommendation server, a third media list of media compatible with one or more items of the first media list. The method also includes merging, by the media server, the first media list, second media list, and third media list to generate a fourth media list. The method also includes selecting, by the media server, an item of media from the fourth media list; and transmitting, by the media server to the device of the first user, an identification of the selected item of media from the fourth media list.

In one embodiment, the method includes modifying the fourth media list responsive to a positive or negative rating of an item of media in the fourth list by the first user. In another embodiment, the method includes requesting the third media list of media compatible with one or more items of the first media list and a second one or more items of media positively rated by the first user. In a further embodiment, the second one or more items of media positively rated by the first user comprise one or more items of a previously generated customized media playlist.

In some embodiments, the method includes requesting the third media list of media compatible with one or more items of the first media list selected in order from the first media list. In other embodiments, the method includes filtering the list to remove one or more recently selected items of media, responsive to one or more business rules.

In one embodiment, the method includes receiving, by the media server, an identification of a second user to receive the identification of the selected item of media from the fourth media list; modifying the fourth media list, by the media server, responsive to a combination of preferences of the first user and second user; and transmitting an identification of the selected item of media from the fourth media list to a device of the second user. In a further embodiment, the method includes retrieving positive and negative ratings of artists by each of the first user and second user; merging positive and negative ratings for each artist from the retrieved ratings to generate a combined score for each artist; comparing each combined score to a threshold; and modifying the fourth media list to remove items of media by artists with combined scores below the threshold. In another further embodiment, the method includes retrieving positive and negative ratings of items of media by each of the first user and second user; merging positive and negative ratings for each item of media from the retrieved ratings to generate a combined score for each item of media; comparing each combined score to a threshold; and modifying the fourth media list to remove items of media with combined scores below the threshold. In some embodiments, the method includes modifying the list to include in a first position an item of media by the first seed artist.

In another aspect, the present disclosure is directed to a system for generating customized media playlists. The system includes a first device comprising a media server, in communication with a device of a first user. The first device is configured for receiving, from the device of the first user, a request to generate a customized media playlist, the request including an identification of a first seed artist; and requesting, from a recommendation server, a first media list of media of the first seed artist. The first device is also configured for requesting, from the recommendation server, a second media list of media compatible with the first seed artist; and requesting, from the recommendation server, a third media list of media compatible with one or more items of the first media list. The first device is also configured for merging the first media list, second media list, and third media list to generate a fourth media list; selecting an item of media from the fourth media list; and transmitting, to the device of the first user, an identification of the selected item of media from the fourth media list.

In one embodiment, the first device is further configured for modifying the fourth media list responsive to a positive or negative rating of an item of media in the fourth list by the first user. In another embodiment, the first device is further configured for requesting the third media list of media compatible with one or more items of the first media list and a second one or more items of media positively rated by the first user. In a further embodiment, the second one or more items of media positively rated by the first user comprise one or more items of a previously generated customized media playlist.

In another embodiment, the first device is further configured for requesting the third media list of media compatible with one or more items of the first media list selected in order from the first media list. In yet another embodiment, the first device is further configured for filtering the list to remove one or more recently selected items of media, responsive to one or more business rules.

In one embodiment, the first device is further configured for receiving an identification of a second user to receive the identification of the selected item of media from the fourth media list; modifying the fourth media list, responsive to a combination of preferences of the first user and second user; and transmitting an identification of the selected item of media from the fourth media list to a device of the second user. In a further embodiment, the first device is further configured for retrieving positive and negative ratings of artists by each of the first user and second user; merging positive and negative ratings for each artist from the retrieved ratings to generate a combined score for each artist; comparing each combined score to a threshold; and modifying the fourth media list to remove items of media by artists with combined scores below the threshold. In another further embodiment, the first device is further configured for retrieving positive and negative ratings of items of media by each of the first user and second user; merging positive and negative ratings for each item of media from the retrieved ratings to generate a combined score for each item of media; comparing each combined score to a threshold; and modifying the fourth media list to remove items of media with combined scores below the threshold. In some embodiments, the first device is further configured for modifying the list to include in a first position an item of media by the first seed artist.

In another aspect, the present application is directed to systems and methods for delivering a video stream or pseudostream on-demand and in synchronization with an already playing audio stream or pseudostream. A user listening to audio may decide they wish to view a related video, such as a music video for a song, and may select to view the video during playback. Without requiring the user to open a different application or website or restart playback of the song, the system may dynamically deliver video data at a starting playback point responsive to a current playback of the audio. The video may be displayed to the user, automatically in synchronization with the audio, without needlessly consuming bandwidth during periods when the user does not wish to view the video.

The application describes a method for dynamically switching between playback of various types of multimedia programming. The method includes receiving, by a device of a user from a multimedia server, a first item of audio content. The method also includes playing, by the device, the first item of audio content for the user. The method further includes requesting, by the device, a second item of video content corresponding to the first item of video content. The method also includes receiving, by the device from the multimedia server, the second item of corresponding video content. The method also includes displaying, by the device in synchronization with the playback of the first item of audio content, the second item of corresponding video content.

In one embodiment, the method includes transmitting a request to the multimedia server, by the device, responsive to receiving a request of the user to display the video content during playback of the first item of audio content. In another embodiment, the method includes receiving a playback start time for the second item of corresponding video content from the multimedia server, the playback start time allowing display of the second item of corresponding video content in synchronization with the playback of the first item of audio content.

In some embodiments, the second item of video content is received with the first item of audio content, prior to a request of the user to display the video content. In other embodiments, the first item of audio content and second item of video content comprise a multimedia advertisement. In a further embodiment, the method includes determining that the user is viewing a display of the device, and requesting the second item of video content or displaying the second item of corresponding video content is performed responsive to the determination. In a further embodiment, determining that the user is viewing a display of the device includes determining that the display of the device is on. In yet another embodiment, the method includes receiving, by the device from the multimedia server, a banner advertisement corresponding to the multimedia advertisement; and displaying the banner advertisement during playback of a subsequent item of audio or video content.

In another aspect, the present application is directed to a system for dynamically switching between playback of various types of multimedia programming. The system includes a device of a user receiving, from a multimedia server, a first item of audio content. The device is configured for playing the first item of audio content for the user. The device is also configured for requesting a second item of video content corresponding to the first item of video content. The device is further configured for receiving, from the multimedia server, the second item of corresponding video content. The device is also configured for displaying, in synchronization with the playback of the first item of audio content, the second item of corresponding video content.

In one embodiment, the device is also configured for transmitting a request to the multimedia server, responsive to receiving a request of the user to display the video content during playback of the first item of audio content. In another embodiment, the device is configured for receiving a playback start time for the second item of corresponding video content from the multimedia server, the playback start time allowing display of the second item of corresponding video content in synchronization with the playback of the first item of audio content.

In some embodiments, the second item of video content is received with the first item of audio content, prior to a request of the user to display the video content. In other embodiments, the first item of audio content and second item of video content comprise a multimedia advertisement. In a further embodiment, the device is also configured for determining that the user is viewing a display of the device, and requesting the second item of video content or displaying the second item of corresponding video content is performed responsive to the determination. In a further embodiment, the device is configured for determining that the display of the device is on. In yet another embodiment, the device is also configured for receiving, from the multimedia server, a banner advertisement corresponding to the multimedia advertisement; and displaying the banner advertisement during playback of a subsequent item of audio or video content.

In yet another aspect, the present application is directed to systems and methods for simultaneous and synchronized customized media delivery to a plurality of users. A media provider may maintain a timeline and current playback time of media displayed on user devices. When a new user joins the customized media station, the provider may provide files for playback, along with an identifier of the current playback time. The new user's device may start playing the current file at the current playback time, in approximate synchronization with users already viewing or listening to media of the customized media playlist. The present application describes a method for providing synchronized playback of media to a plurality of users. The method includes receiving, by a controller executed by a computing device, a first request from a first device of a first user for an item of media of a customized media playlist. The method also includes transmitting, by the controller to the first device, an identification of the item of media and a playback start time for the item of media. The method further includes receiving, by the controller, a subsequent second request from a second device of a second user for the item of media. The method also includes transmitting, by the controller to the second device, an identification of the item of media and the playback start time transmitted to the first device for the item of media, wherein the first device and second device output the item of media in substantial synchronization according to the playback start time.

In one embodiment of the method, the first request does not specify the item of media, and the method further includes selecting, by the controller, the item of media from the customized media playlist. In another embodiment, the method includes transmitting a uniform resource locator (URL) for the item of media, an identification of a current time of the controller, and an identification of the playback start time. In still another embodiment of the method the subsequent second request does not specify the item of media, and the method includes receiving an identification of the first user or a group comprising the first user. In a further embodiment, the method includes selecting, by the controller, the item of media from the customized media playlist, responsive to receiving the identification of the first user or group comprising the first user.

In some embodiments, the method includes transmitting an identification of an offset time within the item of media to start playback. In other embodiments, the method includes determining, by the controller responsive to receiving the subsequent second request, that a current time is less than the playback start time for the item of media plus a length of the item of media, and wherein transmitting the identification of the item of media and the playback start time to the second device is performed responsive to the determination.

In one embodiment, the method includes receiving, by the controller, a request of the first user or the second user to skip the item of media. The method also includes identifying, by the controller, a second item of media of the customized media playlist. The method further includes transmitting, by the controller to each of the first device and second device, an identification of the second item of media and a playback start time for the second item of media. In a further embodiment, the method includes receiving, by the controller from each of the first device and second device, a playback status request, and transmitting the identification of the second item of media and the playback start time for the second item of media to each of the first device and second device is performed responsive to receiving the playback status request from the corresponding device. In another further embodiment, the method includes transmitting, responsive to receiving the request to skip the item of media, by the controller to the other of the first user or the second user, a request to select to confirm or cancel skipping the item of media. The method also includes receiving, by the controller from the other of the first user or the second user, a confirmation to skip the item of media, and transmitting the identification of the second item of media is performed responsive to receiving the confirmation.

In another aspect, the present application is directed to a system for providing synchronized playback of multimedia to a plurality of users. The system includes a computing device executing a controller in communication with a first device of a first user and a second device of a second user. The controller is configured for receiving a first request from the first device for an item of media of a customized media playlist. The controller is also configured for transmitting, to the first device, an identification of the item of media and a playback start time for the item of media. The controller is further configured for receiving a subsequent second request from a second device of a second user for the item of media, and transmitting, to the second device, an identification of the item of media and the playback start time transmitted to the first device for the item of media, wherein the first device and second device output the item of media in substantial synchronization according to the playback start time.

In one embodiment of the system, the first request does not specify the item of media, and the controller is further configured for selecting the item of media from the customized media playlist. In another embodiment of the system, the controller is further configured for transmitting a uniform resource locator (URL) for the item of media, an identification of a current time of the controller, and an identification of the playback start time to each of the first device and the second device. In yet another embodiment of the system, the subsequent second request does not specify the item of media and the controller is further configured for receiving, from the second device, an identification of the first user or a group comprising the first user. In a further embodiment, the controller is further configured for selecting the item of media from the customized media playlist, responsive to receiving the identification of the first user or group comprising the first user.

In some embodiments of the system, the controller is further configured for transmitting an identification of an offset time within the item of media to start playback to each of the first device and the second device. In other embodiments of the system, the controller is further configured for determining, responsive to receiving the subsequent second request, that a current time is less than the playback start time for the item of media plus a length of the item of media, and transmitting the identification of the item of media and the playback start time to the second device is performed responsive to the determination.

In one embodiment, the controller is further configured for receiving a request of the first user or the second user to skip the item of media; identifying second item of media of the customized media playlist; and transmitting, to each of the first device and second device, an identification of the second item of media and a playback start time for the second item of media. In a further embodiment, the controller is further configured for receiving, from each of the first device and second device, a playback status request, and transmitting the identification of the second item of media and the playback start time for the second item of media to each of the first device and second device is performed responsive to receiving the playback status request from the corresponding device. In another further embodiment, the controller is further configured for transmitting, responsive to receiving the request of the first user or the second user to skip the item of media, to the other of the first user or the second user, a request for the corresponding user to select to confirm or cancel skipping the item of media, and receiving, by the controller, a confirmation to skip the item of media; and transmitting the identification of the second item of media is performed responsive to receiving the confirmation.

In yet another aspect, the present disclosure is directed to a method for providing social interaction in a customized media playlist. The method includes receiving, by a media server, from a first device of a first user, an identifier of a first item of media content and a first data file. The method also includes generating, by the media server, for a second user, a customized media playlist, the customized media playlist comprising the first item of media content. The method further includes transmitting, by the media server to a second device of the second user, the first item of media content and the first data file.

In one embodiment of the method, the first data file comprises a personal message from the first user regarding the first item of media content. In another embodiment, the method includes transmitting the first item of media content and an indication of the first data file; receiving a request of the second user for the first data file; and transmitting the first data file to the second device.

In some embodiments of the method, transmitting the data file to the second device of the second user is performed responsive to identifying an association between the first user and the second user in a social networking system. In other embodiments, transmitting the data file to the second device of the second user is performed responsive to identifying the second user, by the first user. In one embodiment, the first data file comprises a textual message, and the method includes transmitting the first item of media content and the first data file comprises transmitting the first item of media content and the first data file for simultaneous display by the second device. In another embodiment, the first data file comprises a media file, and the method includes transmitting the first item of media content and the first data file comprises transmitting the first item of media content and the first data file for subsequent playback by the second device.

In another aspect, the present disclosure is directed to a system for providing social interaction in a customized media playlist. The system includes a device comprising a media server in communication with a first device of a first user and a second device of a second user. The media server is configured for receiving, from the first device of a first user, an identifier of a first item of media content and a first data file. The media server is also configured for generating a customized media playlist for the second user, the customized media playlist comprising the first item of media content. The media server is also configured for transmitting, to the second device of the second user, the first item of media content and the first data file.

In some embodiments of the system, the first data file comprises a personal message from the first user regarding the first item of media content. In other embodiments of the system, the media server is configured for transmitting the data file to the second device of the second user responsive to identifying an association between the first user and the second user in a social networking system. In still other embodiments, the media server is configured for transmitting the data file to the second device of the second user responsive to identifying the second user, by the first user. In yet still other embodiments, the first data file comprises a media file, and the media server is configured for transmitting the first item of media content and the first data file for subsequent playback by the second device.

In still another aspect, the present application is directed to systems and methods for simultaneous group customization and collaboration of preferences for a customized media playlist. Users consuming a customized media playlist simultaneously may provide individual user preferences regarding items of media content, and the media provider may customize the media list responsive to democratic polling or voting of the users.

The details of various embodiments of the invention are set forth in the accompanying drawings and the description below.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1A is a block diagram illustrative of an embodiment of a networked environment useful for the systems and methods described in this document;

FIG. 1B is a block diagram illustrative of a certain embodiment of a computing machine for practicing the methods and systems described herein;

FIG. 1C is a block diagram illustrative of another embodiment of a computing machine for practicing the methods and systems described herein;

FIG. 2A is a block diagram of an embodiment of a system for providing a socially-interactive media streaming service;

FIG. 2B depicts an embodiment of an interface provided by a client agent executing on a client device;

FIG. 3A depicts an embodiment of an interface provided by a client agent that displays available stations;

FIG. 3B depicts an embodiment of an interface provided by a client agent that displays additional information pertaining to a station selected by the user;

FIG. 3C depicts an embodiment of an interface provided by a client agent that allows a user to create a new station;

FIG. 3D depicts additional exemplary embodiments of interfaces;

FIG. 4 is a flowchart depicting an embodiment of a method of customized media playlist generation and delivery;

FIG. 5A is a Venn diagram depicting an embodiment of a plurality of users with overlapping or shared traits;

FIG. 5B is a table listing an embodiment of traits and profile information for comparing user traits;

FIG. 5C is a flow chart of a method of identifying and weighting similar users;

FIG. 6A is a table depicting an embodiment of a candidate list of media similar to a seed item of media;

FIG. 6B is a block diagram of an embodiment of multiplexing a plurality of candidate lists;

FIG. 7 is a diagrammatic view of an embodiment of a method of adding and removing items from a candidate list;

FIG. 8 is a flow chart of an embodiment of a method of generating a recommendation list for a requesting user based on media preferences of users related to the requesting user;

FIG. 9 is a flow chart of an embodiment of selecting an item of media from a recommendation list;

FIG. 10A is a diagrammatic view of an embodiment of a station timeline with inserted content;

FIG. 10B is a diagrammatic view of embodiments of a station timeline with subsequent playback of inserted content;

FIG. 10C is a diagrammatic view of an embodiment of a station timeline with simultaneous playback of inserted content;

FIG. 11 is a table listening embodiments of methods of adjusting weights of a candidate list and related user responsive to user preferences of an item of media;

FIG. 12A is a diagrammatic view of an embodiment of a station timeline with simultaneous audio and video playback;

FIG. 12B is a flowchart depicting one embodiment of the steps taken to dynamically enable video playback for a user;

FIG. 13A is a diagrammatic view of an embodiment of a station timeline and playback timer for simultaneous synchronized consumption by a plurality of users;

FIG. 13B is a signal flow diagram of an embodiment of providing synchronized playback of media to a plurality of users;

FIG. 13C is a flow chart of an embodiment of a method for providing synchronized playback of media to a plurality of users; and

FIG. 13D is a flow chart of an embodiment of a method for playlist generation and modification and media selection based on social metadata and user preferences.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

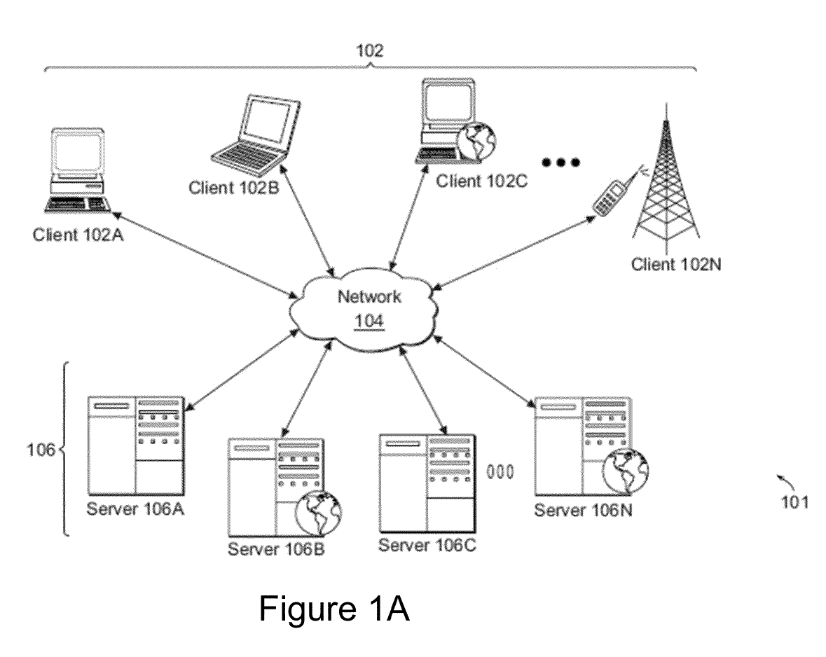

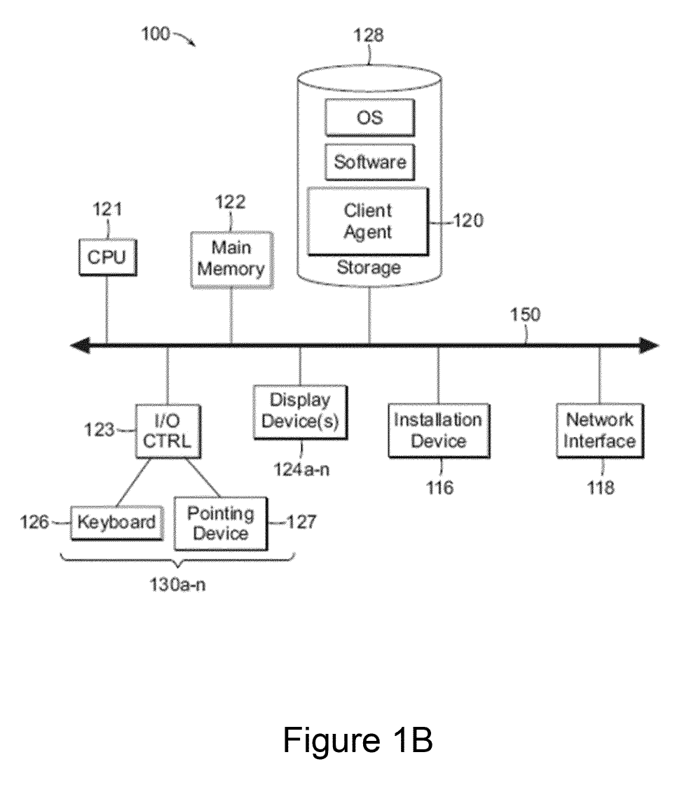

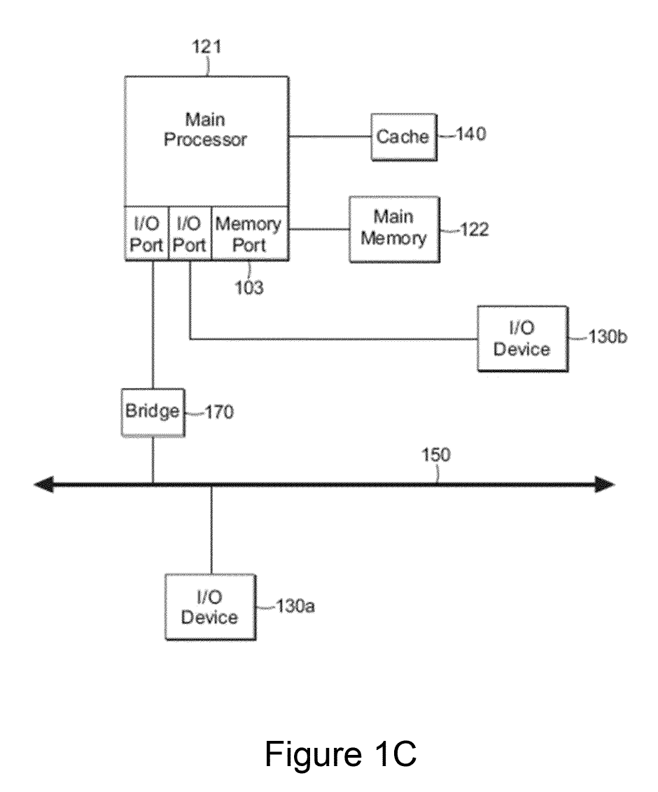

FIG. 1A illustrates one embodiment of a networked environment 101 in which a customized, media streaming service can be provided. As shown in FIG. 1A, the networked environment 101 includes one or more client machines 102A-102N (generally referred to herein as “client machine(s) 102” or “client(s) 102”) in communication with one or more servers 106A-106N (generally referred to herein as “server machine(s) 106” or “server(s) 106”) over a network 104. The client machine(s) 102 can, in some embodiments, be referred to as a single client machine 102 or a single group of client machines 102, while server(s) 106 may be referred to as a single server 106 or a single group of servers 106. Although four client machines 102 and four server machines 106 are depicted in FIG. 1A, any number of clients 102 may be in communication with any number of servers 106. In one embodiment a single client machine 102 communicates with more than one server 106, while in another embodiment a single server 106 communicates with more than one client machine 102. In yet another embodiment, a single client machine 102 communicates with a single server 106. Further, although a single network 104 is shown connecting client machines 102 to server machines 106, it should be understood that multiple, separate networks may connect a subset of client machines 102 to a subset of server machines 106.

In one embodiment, the computing environment 101 can include an appliance (not shown in FIG. 1A) installed between the server(s) 106 and client machine(s) 102. This appliance can mange client/server connections, and in some cases can load balance connections made by client machines 102 to server machines 106. Suitable appliances are manufactured by any one of the following companies: the Citrix Systems Inc. Application Networking Group; Silver Peak Systems, Inc, both of Santa Clara, Calif.; Riverbed Technology, Inc. of San Francisco, Calif.; F5 Networks, Inc. of Seattle, Wash.; or Juniper Networks, Inc. of Sunnyvale, Calif.

Clients 102 and server 106 may be provided as a computing device 100, a specific embodiment of which is illustrated in FIG. 1B. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected one or more input devices. As shown in FIG. 1B, the I/O controller 123 is connected to a camera 125, a keyboard 126, a pointing device 127, and a microphone 129.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1B illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics processing unit (not shown). The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

Embodiments of the computing device 100 include any one of the following I/O devices 130A-130N: a camera 125, keyboard 126; a pointing device 127; a microphone 129; mice; trackpads; an optical pen; trackballs; microphones; drawing tablets; video displays; speakers; inkjet printers; laser printers; and dye-sublimation printers; touch screen; or any other input/output device able to perform the methods and systems described herein. An I/O controller 123 may in some embodiments connect to multiple I/O devices 130A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; a Thunderbolt or LightPeak bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; WINDOWS 7; WINDOWS MOBILE; and WINDOWS 8; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein.

In other embodiments the computing machine 100 can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device. In yet still other embodiments, the computing device 100 may a smart phone or tablet computer, including products such as the iPhone or iPad manufactured by Apple, Inc. of Cupertino, Calif.; the BlackBerry devices manufactured by Research in Motion, Ltd. of Waterloo, Ontario, Canada; Windows Mobile devices manufactured by Microsoft Corp., of Redmond, Wash.; the Xoom manufactured by Motorola, Inc. of Libertyville, Ill.; the Galaxy Tab family of devices manufactured by Samsung Electronics Co. of Korea; devices capable of running the Android platform provided by Google, Inc. of Mountain View, Calif.; or any other type and form of portable computing device.

In still other embodiments, the computing device 100 can be a virtual machine. The virtual machine can be any virtual machine managed by a hypervisor developed by XenSolutions, Citrix Systems, IBM, VMware, or any other hypervisor. In still other embodiments, the virtual machine can be managed by a hypervisor executing on a server 106 or a hypervisor executing on a client 102.

In still other embodiments, the computing device 100 can in some embodiments execute, operate or otherwise provide an application that can be any one of the following: software; an application or program; executable instructions; a virtual machine; a hypervisor; a web browser; a web-based client; a client-server application; an ActiveX control; a Java applet; software related to voice over internet protocol (VoIP) communications like a soft IP telephone; an application for streaming video and/or audio or receiving and playing streamed video and/or audio; an application for facilitating real-time-data communications; a HTTP client; a FTP client; or any other set of executable instructions. Still other embodiments include a client device 102 that displays application output generated by an application remotely executing on a server 106 or other remotely located machine. In these embodiments, the client device 102 can display the application output in an application window, a browser, or other output window.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS; UMTS; or any other protocol able to transmit data among mobile devices.

The computing environment 101 can include more than one server 106A-106N such that the servers 106A-106N are logically grouped together into a server farm 106. The server farm 106 can include servers 106 that are geographically dispersed and logically grouped together in a server farm 106, servers 106 that are located proximate to each other and logically grouped together in a server farm 106, or several virtual servers executing on physical servers. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

Referring now to FIG. 1C, illustrated is a block diagram of another embodiment of a computing device 100. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports, a memory port 103, and a main processor.

In some embodiments, the computing device 100 may include a cache memory 140 that communicates with a central processing unit 121 via a secondary bus, sometimes referred to as a backside bus. The cache memory 140 can be any memory type, and in some embodiments can be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

The local system bus 150 can, in some embodiments, also be used by the central processing unit to communicate with more than one type of I/O device 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

In some embodiments, an I/O device 130A-130B may comprise a video or still camera, and central processor 121 may use the camera to record one or more images as user content, discussed in more detail below. In other embodiments, an I/O device 130A-130B may comprise a microphone for recording audio user content, discussed in more detail below. In other embodiments, an I/O device 130A-130B may comprise a display for displaying one or more static or video images to a user, including user content or video media content, as well as advertising, text, images, interactive user interface elements, or other objects. In still other embodiments, an I/O device 130A-130B may comprise one or more amplifiers, speakers, or audio transducers, including headphones, for playing audio content to a user, including user content or audio media content, as well as advertising, user interface elements such as clicks or beeps, or other audio objects. I/O device 130A-130B may further comprise a touch screen, keypad, switch, knob, button, or other interface for accepting commands or other input from a user.

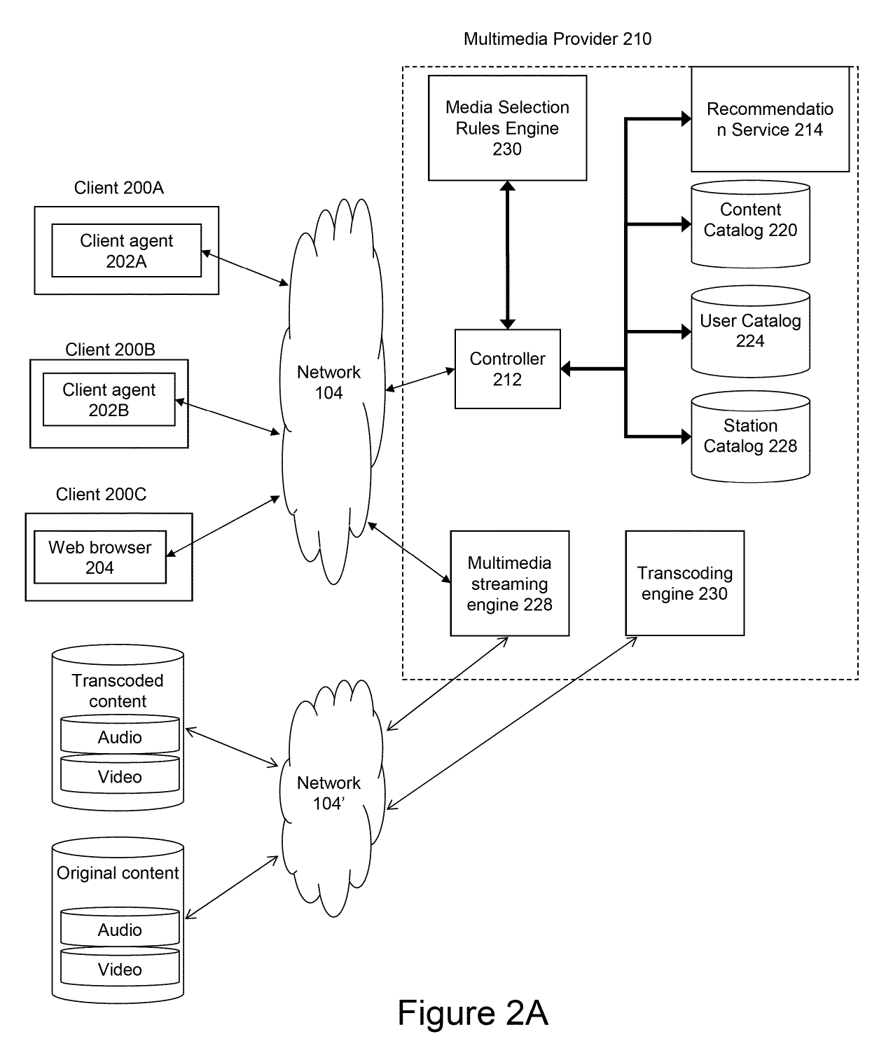

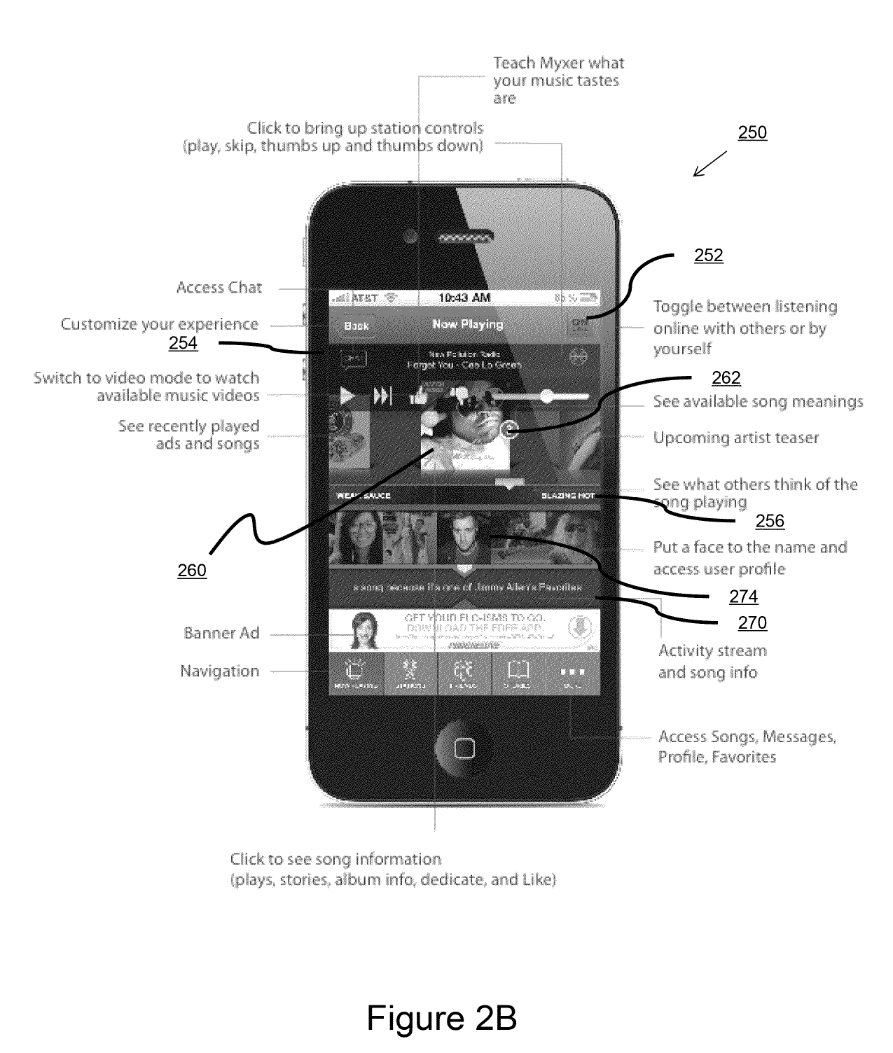

Referring now to FIG. 2A, and in brief overview, an embodiment of a socially-interactive, media service is depicted. As shown in FIG. 2A, one or more client devices 200A-200C communicate with a media provider 210 via network 104. The media provider 210 shown in FIG. 2 includes a controller 212 in communication with an recommendation service 214, a media content catalog 220, a user content catalog 224, a station catalog 228 and a media selection rules engine 230. The media provider 210 also includes a media streaming engine 240 that accesses original content, and transcoded content, via network 104; for example, the original content and transcoded content may be stored on a third-party storage service such as the Amazon Simple Storage Service, provided by Amazon.com, Inc. of Seattle, Wash. Although shown in FIG. 2A as separate networks, network 104 and network 104′ may be, in fact, the same network.

Still referring to FIG. 2A, and in greater detail, an embodiment of a client 200C is depicted that executes a web browser 202C to communicate with the media provider 210. In these embodiments, client 202C may be desktop, laptop, or tablet computers capable of executing the web browser 202C. The web browser may include a plug-in or extension that provides the functionality described below. Alternatively, the web browser 202C may be provided with an HTML page include ActiveX controls or Javascript that, when executed by the web browser, provide the desired functionality.

FIG. 2A also depicts embodiments of clients 200A, 200B on which a dedicated client agent 202A and 202B execute. In some embodiments, the client agent 202A, 202B may reside as firmware in a client 200A, 200B. In other embodiments, the client agent may be downloaded and installed in the client 200A, 200B, either directly over a wireless network or by synchronizing the client 200A, 200B with a personal or laptop computer to which the agent 202 has been previously downloaded. Client 200A, 200B may also include a camera and/or a microphone for capturing user content and feedback that is ultimately stored by the media provider 210 and transmitted to other users of the system. Whether provided as a dedicated client agent 202A, 202B or a web browser client 202C, the client agent 202 makes requests of the media provider 210 for content, allows the user to provide feedback to the media provider 210, provides a facility for the creation and management of media stations, and manages the playback of audio or combined audio and video.

Still referring FIG. 2A, controller 212 receives and responds to requests made by the client agents 202A, 202B or the web browser agent 202C using information received from one or more of the recommendation service 214, the station catalog 228, the user content catalog 224, the media content catalog 220 and the media selection rules engine 230. The controller 212 may be implemented on a separate physical machine from that of the media selection rules engine 230 and the recommendation service 214. In some of these embodiments, a single physical machine may host more than one controller 214. Alternatively, the controller 212 may be implemented on a separate virtual machine from the machines that provide the media selection rules engine and the recommendation service 214. In these embodiments, the virtual machines used to execute the controller 214 may be provided by a web service such as the Amazon Elastic Compute Cloud provided by Amazon.com, Inc. In further alternatives, the controller 212, media selection rules engine 230 and recommendation service 214 may all be executed by the same physical machine.

The station catalog 228, the user content catalog 224, and the media content catalog 220 each store certain information about the media provider 210 that the controller 214 uses to respond to requests or instructions received by it from the client agents 202. In one embodiment the respective catalogs 220, 224, 228 are relational databases created using, for example, Microsoft SQLServer, sold by Microsoft Corp. of Redmond, Wash. In other embodiments, the respective catalogs are flat file databases created using, for example, Microsoft ACCESS, manufactured by Microsoft Corp. of Redmond, Wash.

The station catalog 228 maintains a store of information relating to stations available from the media provider 210. Information maintained by the station catalog 228 may include a globally unique identifier for the station and one or more of the following items: an identification of the user who created the station; a station name; the seed used to create the station; an identification of one or more users who act as “curators” of the station, that is, they act as moderators of social activity associated with the station; descriptive text associated with the station that is displayed to a consumer or potential consumer; and any other item of information to be associated with a station. For example, the media provider 210 may create a “blues” station that has no “curators”. The station catalog for that station may only maintain the globally unique identifier assigned to the station, the name that should be displayed to a consumer of the station (e.g., “The Blues Station”), the descriptive text for the station (e.g. “All Blues All the Time” or a list of the artists that a consumer can expect to hear when listening to the station; and the seed used to create the station (e.g., “Stevie Ray Vaughn,” “Eric Clapton”).

The media content catalog 220 maintains a store of information relating to media streams available to be sent to a consumer. In one embodiment, information maintained by the media content catalog includes: a globally unique identifier for each item of media; a source locator address of the file storing the item of media; an artist associated with the item of media; a title identifying the item of media; and the duration of the item of media. In other embodiments, the information maintained by the media content catalog further includes the date on which the item of media was created, either as media, as an entry in the database, or both; a genre associated with an item of media

The user content catalog 224 maintains a store of information relating to media streams created by users and transmitted to the media provider 210 to be associated with items of media content. It tracks information similar to that in the media content catalog 220 but for user-created content rather than media content.

The controller 212 maintains a “timeline,” or media queue, for each station that identifies the next item to send to a client 200. The timeline may be stored in the station catalog or, alternatively, it may be stored in volatile memory associated with the machine on which the controller 214 is executing. In one embodiment, the controller 212 creates and maintains the timeline using information from the station catalog 228, media recommendations from the recommendation service 214 and decisions made by the media selection rules engine 230. The controller 212, when placing a new item on the timeline, may decide to send whether to place an identification of a media file, an identification of user content, or an identification of an advertisement. If an advertisement is to be played, the controller 212 sends to the client a Uniform Resource Locator (URL) address directing it to download the advertisement from an ad server (not shown in FIG. 2A). In some embodiments the media provider 210 includes an advertisement catalog (not shown in FIG. 2A) to form the URL address. If user content or media content is to be played, the controller 212 in many embodiments uses information stored in the user catalog 224 to the content catalog 220, respectively, to form a URL address that directs the client 200 to request the user content or the media content from the media streaming engine 240.

In certain of these embodiments, the controller 214 determines that the client device 200 itself maintains a copy of the media file and, in these embodiments, the controller 214 forms an address that directs the client device 200 to retrieve the media file from its local storage. For example, in typical internet radio services, a user is only provided content from the media provider's database. However, in some embodiments, the user may separately have a copy of the content in a local media player database. For example, many users of Pandora also have large Apple iTunes libraries, or Windows Media Player libraries. Rather than needlessly using bandwidth delivering media that the user already has locally, in some embodiments, the client device 200 or a client agent on the device may locate a database of content stored on the device, such as an iTunes playlist (sometimes referred to as a plist) or music database, and send a list of the content to client device 200. Such content may be added to a database associated with the user. Accordingly, when a playlist includes an item of media that the user already has access to, rather than forming a URL address directing the client to the media streaming engine 240, the controller 214 may form a URL address directing the client to a local storage location, either via a localhost IP address such as 127.0.0.1, or via a file:// access call rather than an http:// access or other network request.

The media engine 240 receives the request for the user content or media content from the client 200, retrieves the requested information via network 104′ and returns the media content to the client via network 104. In some embodiments the media engine retrieves and transmits the media stream in its original form. In other embodiments the media engine 240 retrieves and transmits a transcoded version of the media stream. The media engine 240 can send the entire media file to the client prior to playback of the file or, alternatively, the media engine 240 may stream the media file to the client device 200, that is, the client device 200 may begin playback of the media file prior to the completion of the download.

Referring briefly to FIG. 2B, a exemplary interface 250 presented by client agent 202A, 202B is shown. In the embodiment shown in FIG. 2B, a user is provided with an interface 250 for consuming a media stream, whether doing so alone or as part of a larger group. As shown in FIG. 2B, the interface 250 provides a graphical indication 260 of the media stream currently being reproduced. In some embodiments the graphical indication 260 may be selected (by touching or clicking, for example) to reveal a screen displaying further information about the media stream, such as at least one of the following: the number of times the media stream has been played, a collection to which the media stream belongs (for example, the album to which a song belongs), user created content associated with the media stream (such as messages and dedications), a control allowing the user to reflect that they “like” the media stream; and a control to publish information about the media stream to social networking sites such as FaceBook, Twitter, StumbleUpon and Reddit. As shown in FIG. 2B, the graphical indication 260 may also include a badge 262 indicating the number of pieces of user-generated content associated with the media stream. The graphical indication 260 may also allow the user to toggle between different formats for the media stream during playback. For example, as shown in FIG. 2B, a user can toggle between a song and the video for a song, which includes both audio and video. The interface 250 may also include a soft button 252 allowing the user to toggle between individual consumption of a media stream and group consumption of a media stream and a popularity meter 256 that reflects graphically how highly other members of the community rate the currently playing media stream. The interface 250 also includes a control 254 for initiating a chat session. In some embodiments, the chat session may be initiated with other users who are currently consuming the same media stream. In other embodiments, the chat session is initiated with other users that the user of the client 200 has identified as a “friend.” In still other embodiments, the chat control 254 may initiate a chat session with a user that provided user content associated with the current media stream. Other features of the interface 250 depicted in FIG. 2B include a bar 270 for publishing “station events” to consumers, such as the fact that another consumer has indicated that they like or dislike the current media stream or information regarding why the current media stream is being played. As shown in FIG. 2A, if there is a specific user associated with the information published on the bar, a profile picture 274 of that user can be displayed.

Although the embodiment of the interface 250 shown in FIG. 2B is provided by an iPhone device, in other embodiments the client agent 202 operates on a mobile phone using the ANDROID operating system. In other embodiments, the client agent 202 operates in a tablet computing device such as an iPad, Blackberry Playbook or Microsoft Xoom. In still further embodiments the client agent 202 may be a software program capable of execution by a browser application which itself executes in an operating system environment provided by a personal, laptop or virtual computer.

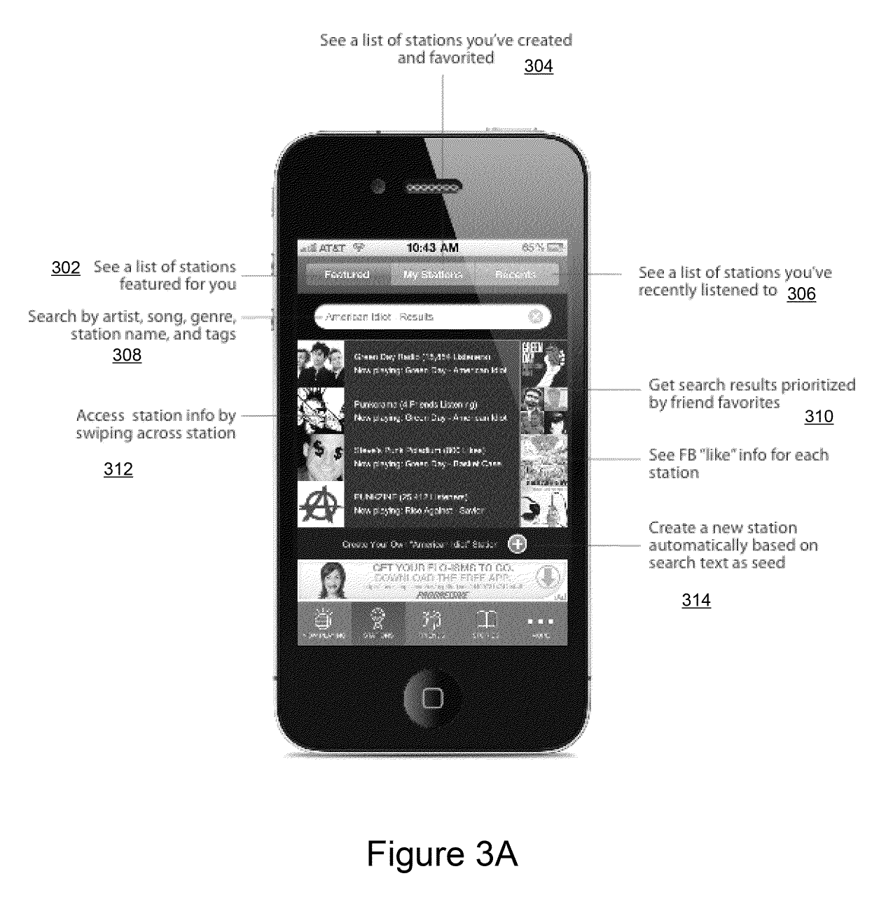

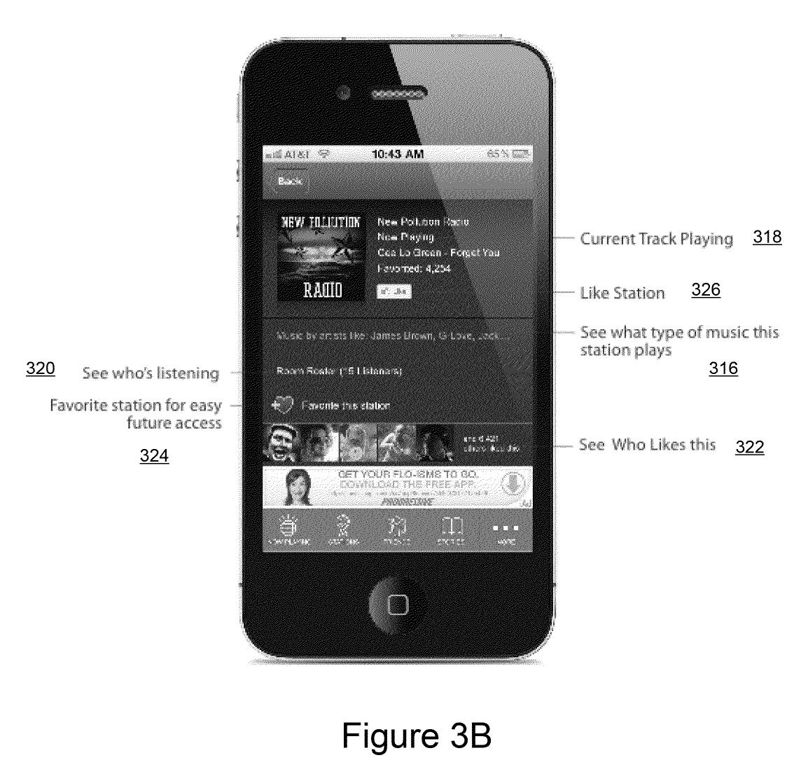

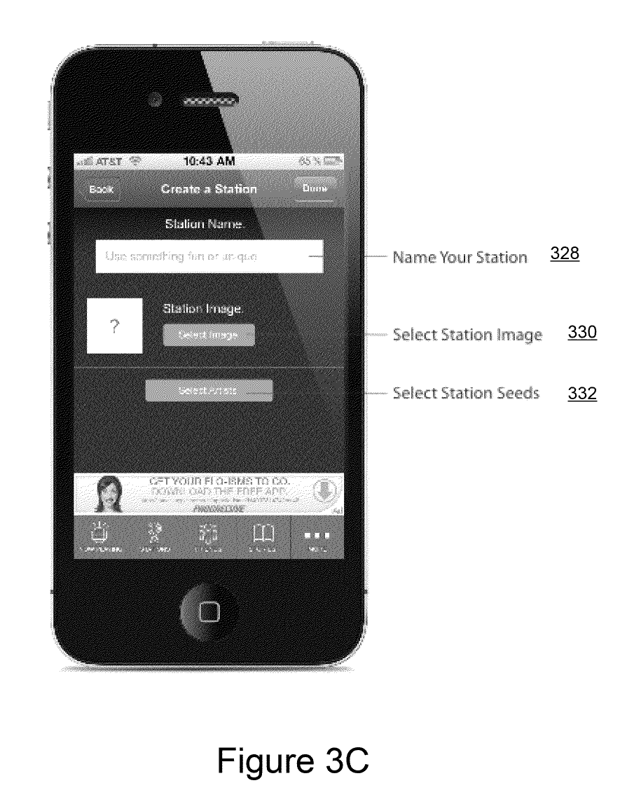

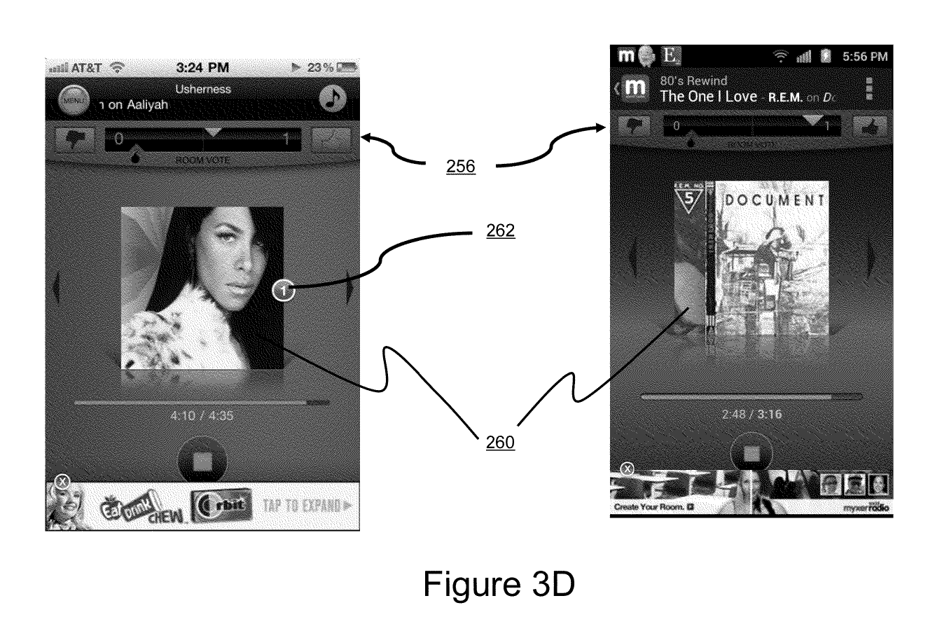

Referring now to FIG. 3A, and in brief overview, an embodiment of a client agent 202 for requesting media is shown. Although illustrated on a portable device, in many embodiments, a user may utilize a web application or application on a desktop client, laptop, or tablet computer to perform the same functions. In brief overview, the client agent 202 may provide a list of stations featured for the user 302, a list of user-created and/or favorite stations 304, and/or a list of recently listened-to stations 306. In some embodiments, the client agent 202 may provide a list of retrieved stations 310, responsive to a search 308 or selection of list 302, 304, or 306, entered by a user. The user may access station information for each search result station 312, illustrated in FIG. 3B and discussed in more detail below. The user may also decide to create a new station 314, illustrated in FIG. 3C and discussed in more detail below. As used in this document, the term “station” refers to any collection of media streams that are grouped together logically.

Still referring to FIG. 3A and in more detail, in some embodiments, the client agent 202 may present a list of featured stations 302 to the user, responsive to a user selection. The list of featured stations 302 may include one or more stations created by other users, or the media provider 210, that correspond to one or more user preferences. For example, the user may have expressed a preference for country music. The media provider 210 may determine that a station using Garth Brooks as an artist seed corresponds to this user preference, and can place that station in a list of featured stations to be presented to the user. In other embodiments, the featured stations may be based off other information provided by the user. For example, the user may follow an artist's social networking feed, and the media provider 210 may identify the relationship and add a station corresponding to the artist to the featured stations. In one embodiment, the media provider 210 may parse information provided by the user to identify preferences. For example, the user may have mentioned on a social networking feed the fact of their attendance at a concert by an artist, either explicitly or by expressing that they “like” a concert event. The media provider 210 may identify the artist, and add a station corresponding to the artist to the featured stations.

The client agent 202 may also present a list of stations created by the user, or created by other users or the media provider and identified as favorite stations 304, responsive to a user selection. In some embodiments, a user may create a plurality of stations. For ease of finding and returning to these stations, the stations may be listed for the user. In some embodiments, the stations may be listed in chronologically-created order, in order of most recent access, or in alphabetical order. In many embodiments, the user may listen to stations created by other users or the media provider. When listening, if the user likes the station, they may be able to identify the station as a “favorite” station. Such favorite stations also may be added to the list 304. Thus, list 304 may include a list of stations to which the user has previously listened and may wish to return.

The client agent 202 may also present a list of stations recently listened accessed 306, responsive to user selection. Similar to the list of favorite stations 304, the list of recent stations 306 may comprise a list of stations accessed within a predetermined time period, or a predetermined number of the most recently accessed stations. Recent stations 306, unlike favorite stations 304, may include stations that were created by other users but not identified by the user as favorite at the time. The user may return to these stations to identify them as favorites so that they appear in list 304. In other embodiments, the most recent station or stations may also be favorite stations, but may be more easily accessed by the user. For example, list 306 may be less cluttered than list 304.

The client agent 202 may also provide a search interface 308. A user may use search interface 308 to search for stations by artist, song, genre, album title, station name, or one or more tags or keywords related to the station or media. Search results may include one or more stations related to the search string. In some embodiments, the user may use the search query 308 to generate a new station 314.

In one embodiment, responsive to the user entering a search string or selecting one of lists 302, 304, or 306, the client agent 202 may transmit a query to a controller or server for the corresponding list or a list of stations corresponding to the search string. The query may comprise an identification of the user, and an identification of the list or the search string. The server or controller may respond with a list of stations 310. In some embodiments, as when the user has requested list 302, 304, or 306, the server may respond with a list of stations in order of priority, chronological creation date, or last accessed date. In embodiments where the user has requested stations corresponding to a search string, or one of lists 302, 304, or 306, the server may respond with the list of stations prioritized by the number of the user's friends that are listening to the station, have listened to the station, or have liked the station.

In some embodiments, the list of stations 310 may comprise one or more station identifiers 312 corresponding to the requested item or search string. In one embodiment, each station identifier 312 may comprise a picture, such as an artist picture, a picture of a user who created the station, an icon representative of a genre of the station, an album cover representative of the station, or any other indicator. In another embodiment, each station identifier 312 may comprise a name of the station. In still another embodiment, each station identifier 312 may comprise a name of a currently playing item of media on the station, a next-playing item of media on the station, and/or a picture of an album including the currently playing or next-playing song or other identifier of the next playing item of media on the station. In some embodiments, each station identifier 312 may further comprise an identification of a number of listeners or viewers of the stations, a number of friends of the user who are listening to or viewing the station, a number of items of media of the station's playlist that the user has liked, or any other available information. In one embodiment, the user may select a station identifier 312 to learn more information about the station or start listening to the station.

If the user is not interested in listening to a currently existing station in the list, or a station from one of lists 302, 304, or 306, the user may use the search string 308 to generate a new station 314. Responsive to a user selection, the client agent 202 may transmit a request to a controller or server of a media provider to generate a new station. In some embodiments, the generated includes a user identification and the search string. The search string may be used as a seed to generate the new station, or may be used to generate a seed for the station.

Referring now to FIG. 3B, one embodiment of an interface provided by a client agent 202 for viewing station information about a station is shown. Although illustrated on a portable device, in many embodiments, a user may utilize a web application or application on a desktop client, laptop, or tablet computer to perform the same functions. In brief overview, the client agent 202 may provide a station description 316, a currently playing track 318 on the station, a list of currently-listening users 320 or access to such a list, and a list of users that have liked the station and/or currently playing item of media 322 or access to such a list. In some embodiments, the client agent 202 may provide an interface 324 for allowing the user to add the station to a list of favorite stations 304. In another embodiment, the client agent 202 may provide an interface 326 for transmitting a status update or “like” indicator to a social networking service, such as Facebook. In some embodiments, the client agent 202 transmits a request to join or listen to the station, responsive to the user selecting to view the station information, while in other embodiments, the client agent 202 may provide a “listen to this station” button or interface (not illustrated) for user selection. In such embodiments, the client agent 202 may transmit the request to join or listen to the station responsive to the user selection of the button.

Still referring to FIG. 3B and in more detail, in some embodiments, a client agent 202 may provide a station description 316 to a user. Station description 316 may comprise one or more of a station name, a station genre, an artist name, and an identifier of a seed or seeds used to generate the station. In some embodiments, station description 316 may comprise a short description of the station written by a user, the user who created the station, the media provider, an artist whose work is played by the station, an advertiser associated with the station, or any other entity.

In some embodiments, the client agent 202 may provide an identification of a currently playing track 318 on the station. In other embodiments, such as when the station is paused or the user is joining the station in solo listening mode, discussed in more detail below, the client agent 202 may provide an identification of a next playing track 318. The currently playing or next playing track information 318 may comprise a title, artist name, image of the artist or album cover, icon, genre, or other information. In one embodiment, currently playing or next playing track information 318 may comprise an identifier of a number of listeners that have liked the item of media, or a number of the user's friends that have liked the item of media.

In one embodiment, the client agent 202 provide a list or access to a list of users that are currently listening to the station 320. In some embodiments, the user may utilize the list to view who is listening to a station in real-time. In one embodiment, the client agent 202 may filter the list by friends of the user, or may prioritize the list based on friends of the user, such that the user's friends appear first in the list of listeners.

The client agent 202 may also provide a list or access to a list of users that have liked the station or liked the currently playing or next playing item of media 322. As discussed above, in some embodiments, the client agent 202 may filter the list 322 by friends of the user, or may prioritize the list 322 based on friends of the user, such that the user's friends appear first in the list of users that have liked the station, or liked the currently playing or next playing item of media 322.

The client agent 202 may also provide an interface 324 for the user to add the station to a list of favorite stations. In some embodiments, responsive to the user selecting the interface 324, the client agent 202 may transmit a request to a server or controller comprising an identification of the user and an identification of the station, the request indicating to add the station to a list of favorite stations 304.

In another embodiment, the client agent 202 may provide a second interface 326 for the user to update a social networking status with the station identification, or share the station with friends via a social networking site, such as Facebook. In one embodiment, the client agent 202 may transmit a request to an operator of a social networking site to update a status identifier for the user with an identification of the station or to add the station to a list of items liked by the user. Friends of the user may receive an update via the social networking site, via a corresponding interface 326 with which they are interacting, or both. In many embodiments, the update includes the station identification information. In some embodiments, a friend of the user may select the update to transmit a request to the media provider to listen to the station, the request comprising the station identification. That is, via the social networking site, a user may invite friends to listen to the station.

Referring now to FIG. 3C, in some embodiments, the client agent 202 may provide an interface to allow the user to create a new station. In brief overview, the user may provide a station name 328, station image 330, and one or more station seeds 332. In some embodiments, the user may provide a description of the station and/or a user story related to the station, discussed in more detail below.

Still referring to FIG. 3C, in some embodiments, the user may provide a station name 328 and/or a station image 330. In one embodiment, a station name 328 may be automatically suggested, based on a search string provided to the client agent 202. For example, if the user searched for stations related to Johnny Cash, and then chose to create a new station, the client agent 202 may suggest a station name 328 using the phrase “Johnny Cash”. Similarly, in some embodiments, the client agent 202 may suggest a station image 330 based off the search string, such as a picture of an artist named in the search string, an album cover of an album or item of media named in the search string, an icon representing a genre named in the search string, or any other information.

In some embodiments, the user may provide one or more station seeds 332 to generate a station. In some embodiments, a station seed 332 may comprise an artist name, a song name, an album name, a show name, a movie name, an actor or actress name, a record company or producer name, a director name, a genre, or any other type and form of information for generating a station including media similar to or associated with the provided seed. In some embodiments, the user may provide multiple seeds 332. In one embodiment, the created station may represent a union of the seeds. For example, if the user provides seeds of “Mozart” and “Rap,” the resulting station may include both classical symphonies and works by Dr. Dre. In other embodiments, the created station may represent an intersection of the seeds. For example, with the same seeds, the resulting station may include neither the symphonies nor Dr. Dre, but rather, Falco's “Rock Me Amadeus”.

In some embodiments, the client agent 202 may transmit a request to a controller or media provider server to create a station, the request comprising the station name 328, the station image 330, and/or the one or more seeds 332. In some embodiments, the request may further comprise a station identifier, while in other embodiments, the controller may generate the station identifier when creating the station.

FIG. 3D illustrates additional exemplary embodiments of an interface, such as an interface on an Apple iOS device (left) and an interface on an Android OS device (right). As shown, each interface may include an indicator of a currently playing item of media 260, a badge for user stories 262, and a popularity meter 256.

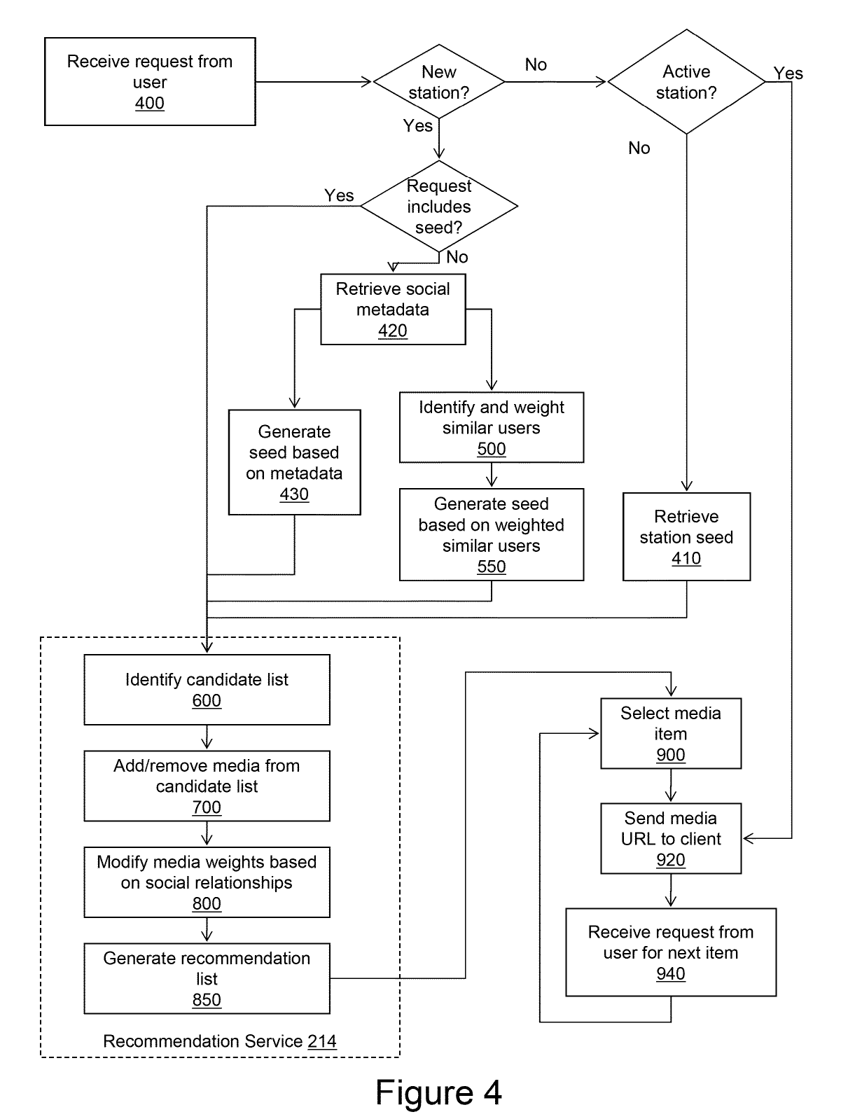

Referring now to FIG. 4, illustrated is a flow chart of a method for generating a station and delivering media related to the station. In brief overview, a media delivery system or controller receives a request from a user or computing device of a user, at step 400. The request may comprise a request to listen to or join an existing station and may include an identification of the existing station, or may be a request to generate or create a new station. If the request is to join an existing station, the existing station may be active and currently being listened to by one or more other users, or may be inactive, paused, or set for solo listening. If the request is to join an existing station with active listeners, then the current item of media URL may be sent to the client at step 920, discussed in more detail below. If the request is to join an existing, but inactive station, then at step 410, in some embodiments, a corresponding station seed may be retrieved from a station catalog for transmission to a recommendation service 214. If the request is to create a new station and does not include a seed, a seed may be generated based on retrieving social metadata such as from a social networking site (e.g. Facebook, LinkedIn, Twitter, MySpace, or any other social networking site) at step 420, and either generating a seed based on the metadata at step 430, or identifying and weighting similar users at steps 500 and 550 for transmission to the recommendation service 214. In other embodiments, the request may be to create a new station and may include one or more seeds for transmission to the recommendation service 214, as discussed above in connection with FIG. 3C.

The seed or seeds may be passed or transmitted to a recommendation service 214. At step 600, the recommendation service may identify a candidate list corresponding to the seed. The candidate list may comprise a list of similar items of media to the seed item of media or items of media related to the seed artist or genre. In some embodiments, the candidate list may comprise similarity weights for each similar item of media, while in other embodiments, the candidate list may be implicitly weighted by order, where the first item in the list is the most similar, and the last item in the list is the least similar. At step 700, the recommendation service may add and remove items of media from the candidate list. At step 800, the recommendation service may modify the explicit or implicit weights of items of media in the candidate list based on the requesting user's social relationships. At step 850, the recommendation service may generate a recommendation list, and may return or transmit the recommendation list to the controller 212.

At step 900, in some embodiments, the controller 212 may select an item of media from the recommendation list. In other embodiments, the recommendation service 214 may select an item of media from the recommendation list and transmit an identification of the selected item of media to the controller. At step 920, the controller 212 may transmit a URL for the song to the client, so that the client may retrieve the item of media. At step 940, the controller may receive a request from the client for a next item of media. In some embodiments, the controller may repeat steps 900-940, while in other embodiments, the controller may transmit the request for a next item of media to the recommendation service 214, which may perform step 900 and respond with a next item of media identification to the controller, which may repeat steps 920-940.

Still referring to FIG. 4 and in more detail, at step 400, a media provider, controller, or server may receive a request for media from a computing device of a user. In one embodiment, the request may comprise a request to join or listen to an existing, active station. For example, as discussed above in connection with FIG. 3A, the user may identify an existing station that they wish to listen to, and may select the station, initiating a request to join the station. The request may comprise an identification of the user, an identification of the station, a preferred audio format, a preferred video format, a preferred audio quality, a preferred video quality, a social networking site profile identifier, or any other type and form of information.

In some embodiments, responsive to receiving a request to join an existing, active station, the media provider or controller may reply with a URL for a currently playing item of media or a next playing item of media for the client to retrieve at step 910. In one embodiment, the media provider or controller may reply with a current time in the item of media. For example, and discussed in more detail below, if a user joins a station that is currently 2 minutes and 10 seconds into an item of media, the media provider may reply with a URL of the currently playing item of media, plus an indicator that the client should start playing the item of media at 2 minutes and 10 seconds into the item of media. This allows the client to synchronize with other current listeners, without having to multicast content. In some embodiments, the client may be directed to start playing the item of media at a slightly later time, to allow for latency and processing delays.

In another embodiment, the request from the client may comprise a request to join an existing, but inactive station. An inactive station may comprise a station with no current listeners, or a station in solo listening mode. As there may be no currently playing items of media on such stations, in some embodiments, the controller or media provider may retrieve a station seed corresponding to the station at step 410. This may be done to allow the media provider to generate a playlist corresponding to the existing station, for selecting a next item of media to send to the listener. In some embodiments, however, the media provider may retain a previously generated playlist for the station and skip steps 410-850. This may reduce processing requirements. However, the station playlist may not represent recent trends or similarities between the station seed and new items of media or artists, unreleased at the time of creation of the older playlist. In some embodiments, the media provider may determine if the playlist is “stale” or has not been generated within a predetermined time period, such as one week, two weeks, or any other time period. If the playlist is not stale, then steps 410-850 may be skipped.

As discussed above, a station seed may comprise an artist name, a song name, an album name, a show name, a movie name, an actor or actress name, a record company or producer name, a director name, a genre, or any other type and form of information for generating a station including media similar to or associated with the provided seed. In some embodiments, retrieving a station seed at step 410 may comprise querying a station database or catalog for a seed associated with a station identifier or name. For example, in one embodiment, the request may comprise a station ID. At step 410, the controller or provider may query a database for a seed corresponding to the station ID in the request.

In still another embodiment, the request from the client may comprise a request to create a new station, and may include a seed for the station. In some embodiments, responsive to receiving the request, the controller or provider may create a new station in a station catalog or database, and may associate the seed with the newly created station. In some embodiments, the controller may assign a station ID to the newly created station, while in other embodiments, the request may include a station ID to be assigned to the newly created station. In one such embodiment, the station ID may be generated based off information in the request, such as one or more of a timestamp, a requesting user ID, a source IP address of the requesting user, a sequence ID of the request, a station name, a station picture, a station description, or a hash of any or all of these values or any other information. In some embodiments, the request may comprise a station name and/or picture, and the controller may store the name and a reference to the picture in the station database with the station.

In still yet another embodiment, the request from the client may comprise a request to create a new station, but may not include a seed for the station. Unlike the embodiment illustrated in FIG. 3C in which a user explicitly generates a new station, in some embodiments, requests for new stations without seeds may be generated when a user first connects to the media provider. For example, rather than waiting for the user to provide a seed or request to join a station, it may be desirable to immediately provide music that the system believes the user will enjoy. In one example embodiment, a link to the media provider may be provided to a user through a friend's post on a social networking site such as Facebook, or via a widget or application. If the user clicks on the link, the media provider may create a new station for the user to immediately provide media content, without requiring the user to first provide a seed.

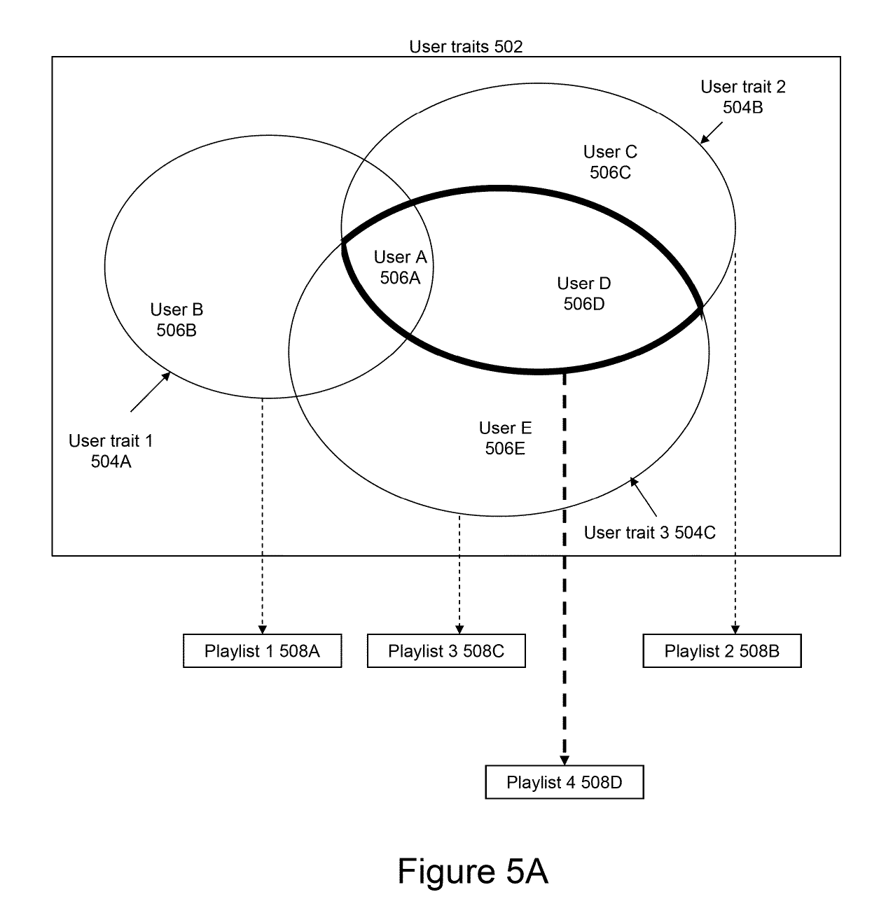

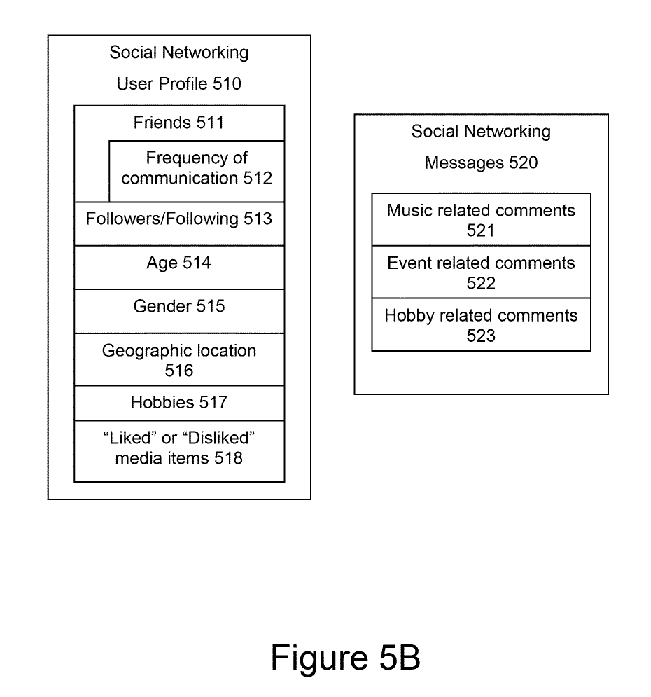

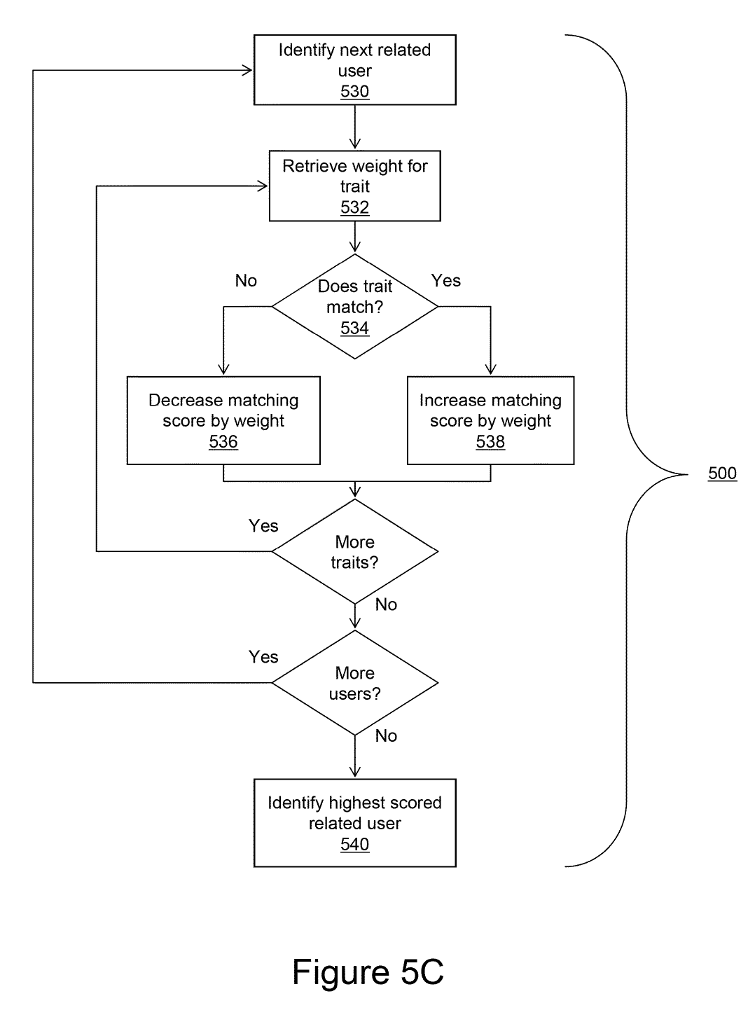

In some embodiments, discussed in more detail below in connection with FIGS. 5A-5C, upon receiving a request to generate a new station that does not include a seed, the media provider may generate a seed for the new station. The media provider may retrieve social metadata from a social networking site at step 420, such as Facebook, Twitter, LinkedIn, or any other social networking site, including social networking sites maintained by the media provider. Social metadata may include demographic data, such as age, geographic location, gender, ethnicity, primary language, or similar data; identifiers of subjective preferences such as Facebook “likes” or items that the user has indicated a positive preference for or followed or “friended” users; comments regarding artists, videos, movies, songs, or books; and/or network relationships such as identified friends, family members, co-workers, etc.

In some embodiments, a seed may be extracted or generated based on this data at step 430. For example, the social metadata may explicitly identify an artist, such as an artist that the user has indicated a positive preference for, followed, or “liked”; or may explicitly identify a song, video, movie, or album by an artist that the user has “liked” or otherwise indicated a positive preference for, such as by leaving a positive review on a shopping site or rating the song or album highly. The social metadata may also implicitly identify an artist, song, video, movie, or album, such as via comments the user has left on a blog post, forum post, news article, or discussion thread that include the name of the artist, song, video, movie or album.

To prevent false positive generation of seeds, in some embodiments, the media provider may present to the user a list of artists including explicitly or implicitly identified artists. For example, if the user has explicitly indicated that they like an artist, and has discussed another artist extensively in a forum, the media provider may present one or both artists to the user as potential seeds.

In another embodiment using social metadata and network relationships, at step 500, the media provider or a recommendation service 214 of the media provider may identify and weight similar users to the requesting user. At step 550, the media provider or recommendation service 214 may generate a seed based on the weighted similar users.

Accordingly, aside from embodiments in which the received request is to join an existent, active station or an inactive station that has a cached playlist, in many embodiments, the media provider or controller may either receive, retrieve, or generate a seed for the station. The seed may then be provided or transmitted to a recommendation service 214 to generate a recommendation list via steps 600-850, discussed in more detail below.

As discussed above, in some embodiments, a seed may be generated at steps 500 and 550. A seed may be generated based off a comparison of the requesting user to other users with profiles in the system. For example, referring briefly to FIG. 5A, illustrated is a Venn diagram 502 of an embodiment of overlapping user traits 504A-504C and users 506A-506E. In some embodiments, a requesting user 506A may share one or more traits 504A-504C with one or more additional users 506B-506E. In one embodiment, the additional users 506B-506E may be related to the requesting user 506A. For example, the requesting user 506A may have each of users 506B-506E as friends in a social networking profile, such as a Facebook profile or Google+ profile. This may additionally limit the number of users to compare to the requesting user, reducing complexity. In other embodiments, the additional users 506B-506E may be implicitly related to the requesting user 506A, such as by all sharing a first user trait.

User traits 504A-504C, referred to generally as user trait(s) 504, may comprise one or more items of information about a user, either explicitly provided by the user, or determined implicitly. In some embodiments, a user may provide a profile listing one or more items of information or traits, such as a name, age, gender, ethnicity, geographic location, hobbies, preferred genre of music, preferred artists or items of media, school attended, profession, employer, favorite sports team, hair color, or any other type of information or trait. In other embodiments, the user may provide the information or traits by filling out a survey or answering questions provided by the system. Traits may accordingly be media related, such as preferred items of media, or non-media related, such as hair color. The latter may be useful in identifying previously undetectable correlations between users and media preferences, which may be desirable for targeted advertising or marketing purposes, as well as providing higher quality media recommendations. For example, if it may be determined that users within a profession are more likely to prefer a particular artist, regardless of the reason, recommendations including that artist may be provided to other users within the profession. Similarly, when playing media related to that artist to users whose professions are unknown, for example, ads related to the profession may be displayed, with a higher likelihood of being relevant to the viewer.

In some embodiments, the media provider may determine the information or traits by parsing a social networking user profile. For example, and referring to FIG. 5B, in some embodiments, the media provider may parse a social networking user profile 510 for a list of friends or acquaintances 511; a frequency of communication with each friend 512. In some embodiments, friends may be weighted more heavily or less heavily, based on how frequently the user communicates with the friend. In another embodiment, the media provider may parse the user profile 510 for one or more of: a user's age or date of birth 514; a user's gender 515; a user's geographic location 516; a user's hobbies 517; a user's “liked” or “disliked” bands or items of media 518; or any other type and form of information. In some embodiments, the information may include one or more of: the user's ethnicity; the user's favorite quotes; the user's favorite sports teams; the user's favorite foods; whether the user participates in a social game, such as Farmville, developed by Zynga, of San Francisco, Calif.; or other information. In one embodiment, the information may further include meta-information, such as how often the user visits the social networking user site, or how often the user tags photos on the site. Such information may be useful as an indicator of how rigorously the user is likely to be regarding rating items of media or artists, and accordingly, how much to weight ratings.

Still referring to FIG. 5B, in some embodiments, to determine traits or information, the media provider or recommendation service may parse social networking messages 520. Messages 520 may comprise music related comments 521, such as a mention of an artist, song, or album title; event related comments 522, such as a mention of a recently attended concert; or hobby related comments 523, such as a mention of a sport or link to an article. By parsing comments, the recommendation service may detect user traits without requiring the user to explicitly list the traits in a profile 510. Additionally, the recommendation service may be able to pull information from different types of social networking sites, regardless of specific layout.

Referring now to FIG. 5C, illustrated is a flow chart of an embodiment of a method for identifying and weighting related users to a first user, as discussed above in step 500 of FIG. 4. In brief overview of FIG. 5C, at step 530, a recommendation service may identify a next related user from a plurality of related users. In some embodiments, the recommendation service may identify a related user responsive to a request from a controller or media provider. At step 532, the recommendation service may identify a trait and retrieve a weight for the trait. At step 534, the recommendation service may identify if a trait of the first user matches the trait of the related user. If not, at step 536, the related user's weight or matching score may be reduced by an amount corresponding to the weight for the trait. If so, at step 538, the related user's weight or matching score may be increased by an amount corresponding to the weight for the trait. Steps 532-538 may be repeated iteratively for a plurality of traits, and steps 530-538 may be repeated iteratively for a plurality of users. At step 540, in some embodiments, the recommendation service may identify a highest scored related user.

Still referring to FIG. 5C and in more detail, at step 530, the recommendation service may identify a second user, or related user, related to the first user, or requesting user. As discussed above, in some embodiments, the requesting user may be a user who has initiated a request to create a station. A related user may comprise a user related to the first user, either explicitly, such as being a friend of the first user on a social networking site, being followed by the first user, following the first user, or implicitly, such as being employees at the same company, living in the same town, or having any other trait in common. In some embodiments, identifying the second user may comprise retrieving, by the recommendation service, a list of friends, followers, followed users, colleagues, family members, or other associated users of the first user from a social networking service, and proceeding iteratively through the list of associated users. In one embodiment, the list of associated users may be ordered based on a frequency of communication between each associated user and the first user. For example, users with whom the first user regularly communicates via the social networking service may be placed higher in the ordered list. Such communications may include writing wall posts, sending public or private messages, tagging photos, playing multiplayer games, commenting on posts, “liking” posts, or any other similar interaction. In a further embodiment, to reduce processing requirements, the number of associated users in the list may be limited to a predetermined number, such as 100, 500, 50, 10, or any other number. In another further embodiment, the number of associated users in the list may be limited based on a time of recent communication, such as associated users with whom the first user has communicated with in the past day, past week, past month, or any other time period. In yet another further embodiment, the number of associated users in the list may be limited based on a frequency of communication, such as associated users with whom the first user has communicated with at least once per day, once per week, once per month, or any other rate.

At step 532, the recommendation service may identify or select a trait from a predetermined list of traits and retrieve a predetermined weight for the trait. In many embodiments, different traits may be weighted differently, based on how well similarity of the trait correlates with media preferences. For example, if it is determined that age correlates highly, such that users of similar ages are highly likely to prefer similar music, the age trait may be heavily weighted. Conversely, if it is determined that hair color correlates poorly, such that similar hair colors provide little indication of whether the users will prefer similar music, the hair color trait may be lightly weighted. Generally, traits such as explicitly preferred bands or albums, age, gender, and geographic location may be weighted more heavily than traits such as whether two users share similar followers, hobbies, or employers. In some embodiments, the recommendation service may dynamically adjust weights as more user preferences are received by the system and more correlations may be determined. For example, the recommendation service may original give gender a heavy weight, but as more and more users interact with the system and rate media, the recommendation service may note that gender does not correlate very well with preferences, or may correlate well within one genre, but not correlate at all within a second genre. Accordingly, trait weightings may be dynamically adjusted as better information about correlations is received.

At step 534, the recommendation service may determine if the first user and second user match for the selected or identified trait. In one embodiment, determining if the first user and second user match may comprise determining a logical AND of the first user and second user's profile or information item. In other embodiments, determining if the first user and second user match may comprise determining if the trait of the first user and trait of the second user are similar or related. For example, if the first user lives in Boston, Mass. and the second user lives in neighboring Cambridge, Mass., the recommendation service may determine that both users live in the Boston metropolitan area, both live in eastern Massachusetts, both live in Massachusetts, both live in New England, both live in the United States, etc. Accordingly, for many traits, users may be not identical, but still similar. In a similar embodiment, the recommendation service may have windows or blocks of values for a trait and compare the users based on these windows. For example, in one such embodiment, the recommendation service may define age ranges such as under 10, 11-13, 14-17, 18-21, 22-25, 26-30, 31-41, 42-65, and 65 and over. A first user of age 32 may be identified as similar to a second user of age 36, based on both ages falling within the same range or window. Accordingly, in some embodiments, traits may be directly compared for exact matches, while in other embodiments, traits may be compared based on similar matches or matches to a range of values. In a further embodiment, traits may be compared in both methods, with exact matches having a higher weight than matches based on a range of values.

If the traits match, then at step 536, a matching score or similarity score between the first user and second user may be increased by an amount proportional to the retrieved weight for the trait. Similarly, at step 538, if the traits do not match, then a matching score or similarity score between the first user and second user may be decreased by an amount proportional to the retrieved weight for the trait. In some embodiments, the increase or decrease amounts may be different. For example, if users are within the same age range, the matching score may be increased by amount n, while if the users are not within the same age range, the matching score may be decreased by amount m. This may be done to reflect that positive correlations may be more accurate than negative correlations. In some embodiments, increasing a matching score at step 538 or decreasing a matching score at step 536 may comprise retrieving a matching score associated with the first user and second user, while in other embodiments, the score may be retrieved at any of steps 530-534. In some embodiments, the matching score may comprise a first default matching score, that may be adjusted upwards or downwards at steps 536-538. For example, because the second user is identified as related to the first user at step 530, in some embodiments, it may be assumed that the users are at least marginally similar, or are more similar than strangers. Accordingly, a default matching score of, for example, 70%, may be used. In other embodiments, any other value may be used as a default score, including 0% and 100%.

In some embodiments, steps 532-538 may be repeated for each of a plurality of traits. For example, steps 532-538 may be repeated for the users' ages, geographic locations, employers, hobbies, ethnicities, genders, preferred bands or albums, preferred sports teams, preferred television shows, lists of other friends, lists of followed other users, lists of followers, or any other type and form of information or traits. Accordingly, through repeated iterations, the matching score between the first and second user may become more and more accurate.

Similarly, in some embodiments, steps 530-538 may be repeated for each of a plurality of related users. As discussed above, in many embodiments, the recommendation service may iterate through a list of the first user's friends to generate a plurality of matching scores between the first user and each of a corresponding plurality of other users. At step 540, in some embodiments, the recommendation service may identify the related user of the plurality of related users with the highest matching score. In some embodiments, where the first user only has a single related user or friend, the system may identify the single related user. In other embodiments where the first user only has a single related user or friend, the recommendation service may seek to identify other similar users, such as users similar to the single related user. For example, if user A is only related to user B, but user B is related to users C, D, and E, the recommendation service may execute steps 530-540 for user A and each of users B, C, D, and E. In some embodiments, the recommendation service may proceed farther down a tree of related users and users related to related users until a predetermined number of users have been compared to the first user, or a user with a matching score to the first user above a predetermined threshold has been identified. In some embodiments, the recommendation service may respond or transmit to the controller or media provider an identification of the related user with the highest matching score.

Referring back to FIG. 4, having identified a related user to the first user with a highest matching score, then at step 550, in some embodiments, the controller or media provider may retrieve a seed or seeds based on the identified related user. For example, in one embodiment, the controller or media provider may retrieve a seed of a most listened to station of the identified related user. In another embodiment, the controller or media provider may retrieve a seed of a most recently listened to station of the identified related user. In another embodiment, the controller or media provider may retrieve a seed of a station of the identified related user with the highest number of media preferences associated with the station. This may be done to ensure that a station playing highly preferred items of media is provided to the first user, rather than a station that the related user has recently created but not yet listened to much, or only listened to a few times. In still another embodiment, the controller or media provider may retrieve a plurality of seeds. For example, in one such embodiment, the controller or media provider may determine a plurality of related users with the highest matching scores, such as the top five matching scores, and select one seed from each.

Still referring to FIG. 4, in some embodiments, at step 600, a recommendation service may identify a candidate list, responsive to a request from a controller, the request including one or more seeds. The seed or seeds may comprise one or more of an artist name, a song name, an album name, a show name, a movie name, an actor or actress name, a record company or producer name, a director name, a genre, or any other type and form of information for generating a station including media similar to or associated with the provided seed. In further embodiments, the seed or seeds may comprise one or more of a user device type (such as Apple iPhone or HTC Droid), user geographical location, a user identifier or ID, one or more user preferences or song preferences, or any other type and form of information.

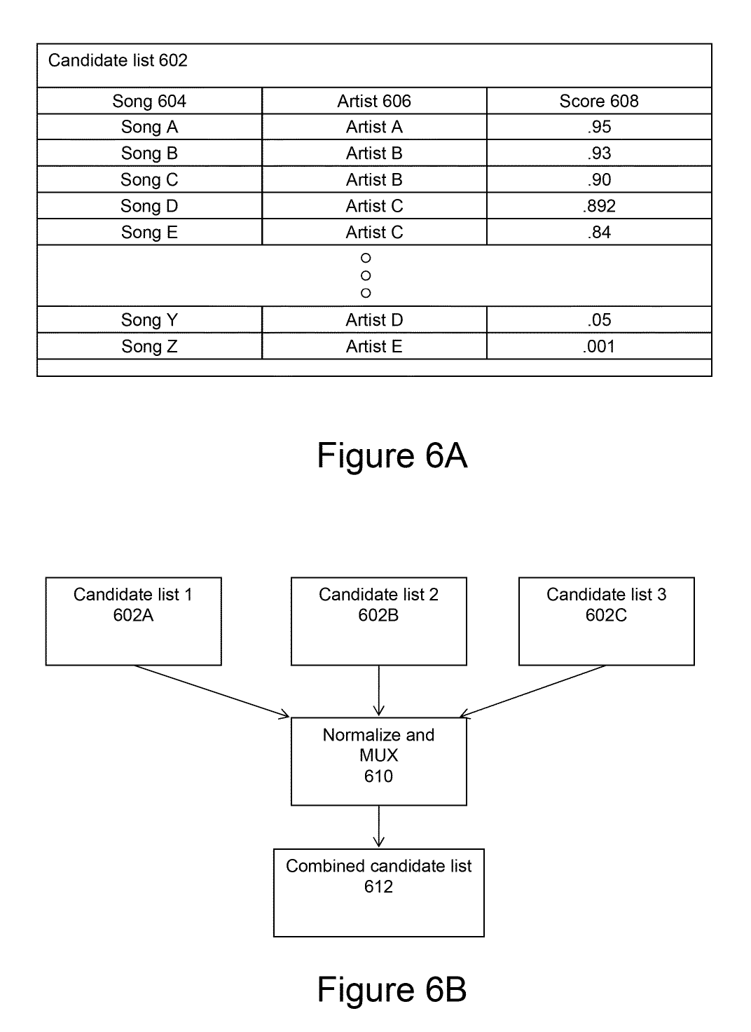

Referring briefly to FIG. 6A, illustrated is a table illustrative of one embodiment of a candidate list 602. In some embodiments, a candidate list 602 may comprise a list of items of media 604 that are similar to a seed item of media, or items of media by a seed artist or genre. In many embodiments, the recommendation service may identify or generate a candidate list from a similarity database. In some embodiments, the similarity database may be retrieved from a third party service, such as Last.fm, by CBS Interactive of San Francisco, Calif.; or the Echo Nest, of Somerville, Mass. In some embodiments, the similarity database may comprise one or more candidate lists for one or more corresponding seeds. Thus, in many embodiments, a candidate list may be a subset of a similarity database, selected responsive to a seed.

In other embodiments, the similarity database may comprise a multi-dimensional similarity-space of items of media, with items of media comprising nodes within the space, placed with regard to similarity. For example, blues songs may be placed in one area of the space, nearby jazz songs and swing songs, while country songs may be placed in another region, with rockabilly songs in between. The distance between two nodes may be easily calculated to determine similarity or dissimilarity. In some embodiments, dimensions for the space may include artist, genre, key, mood, tempo, instrumentation, style, or other characteristics.

In still other embodiments, the similarity database may be generated by explicit associations between items of media by clients of a media delivery service. For example, as more users add two songs to the same playlist, the system may note that the songs are more closely related. In these embodiments, similarity may not refer to the explicit characteristics of the songs themselves, such as style or mood, but rather indicate that users with similar tastes may like both songs. Thus, items of media in a candidate list may comprise items of media that are liked by users who also like the seed song for the candidate list.

In some embodiments, items of media 604 in the candidate list 602 may be identified by titles, while in other embodiments, items of media 604 may be identified by an identification number, catalog number, International Standard Music Number (ISMN), International Standard Recording Code (ISRC), globally unique ID (GUID), or any other type and form of identification number. In some embodiments, the candidate list 602 may comprise an artist name or identifier 606. This may be helpful in distinguishing similar media titles by different artists, but may be unnecessary if the candidate list 602 includes ISRC or ISMN codes or similar identifiers specific to each item of media.

In some embodiments, the candidate list 602 may comprise a score 608. In one embodiment, score 608 may comprise an explicit weighting or score, while in other embodiments, score 608 may be implicit in an ordered candidate list 602. While the example candidate list of FIG. 5 includes artist and score information, in many embodiments, the candidate list may merely comprise a list of identifiers of items of media in a database, such as index numbers, identifier codes, or GUIDs. For example, if the candidate list 602 includes ten items of media 602 without corresponding scores 508, then the recommendation service may identify the first item of media as having a score of 10, the second item of media as having a score of 9, the third item of media as having a score of 8, etc.

Referring now to FIG. 6B, in some embodiments, the recommendation service may comprise or communicate with multiple similarity databases. For example, as discussed above, similarity databases may be generated with different algorithms. Accordingly, while candidate lists from the different databases for a particular seed may significantly overlap, they may still have differences in either weighting or ordering, or inclusion of different items of media. To provide comprehensive recommendations, it may be desirable to retrieve or identify multiple candidate lists 602A-602C from a corresponding multiple similarity databases and multiplex the lists 610 to create a combined candidate list 612.

In some embodiments, multiplexing the lists 610 may comprise interleaving the lists, while in other embodiments, multiplexing the lists 610 may comprise generating a union or intersection of the lists. In still other embodiments, the recommendation service may select a different candidate list for each successive request, in round robin or other algorithm. In a further embodiment, the recommendation service may keep track, via a controller, of which items of media listeners like or dislike, as well as which candidate list or lists 602A-602C include those items of media. If a first candidate list generated from a first similarity database includes more items of media that are disliked than a second candidate list generated from a second similarity database, then the first similarity database may be rated down or weighted against. Similarly, if the first list includes more items of media that are liked than the second list, the first similarity database may be rated up or weighted for. In some such embodiments, the recommendation service may use a weighted round robin to select from the candidate lists, or otherwise weight the candidate lists when multiplexing the lists to generate a combined candidate list 612, responsive to which similarity databases have been preferred or rated higher.

In a similar embodiment, the recommendation service or media provider may issue multiple requests to a similarity database with different inputs or seeds. For example, a media provider may request a first candidate list 602A comprising items of media by the seed artist or artists provided by the user or generated as discussed above. This may be used to guarantee some songs in the combined candidate list 612 by the seed artists. The media provider may also request a second candidate list 602B comprising items of media compatible with the seed artists, which may result in a longer candidate list than list 602A (particularly for new artists or artists without a substantial portfolio of work). A compatible item of media may comprise an item of media by a similar artist or an item of media with similarity to another item of media. For example, a slow jazz song may be compatible with another slow jazz song, but not a speed metal song. Compatibility may be based on styles, genres, beats per minute, key, mode, harmonic or melodic components, instrumentation, vocal style, or any combination of these or other traits, with compatible items of media sharing aesthetic components such that they will likely be liked (or disliked) by the same user within the same media consumption session. The media provider may also request a third candidate list 602C comprising items of media compatible with items of media selected from lists 602A-602B and/or the user's explicit preferences. For example, the media provider may select a first set of items of media by the seed artists and returned in the first candidate list 602A, and a second set of items of media most recently rated positively by the user for the station or similar playlist.

In some embodiments, multiplexing the lists 610 may comprise normalizing each list 602A-602C. For example, in some embodiments, a first list 602A may include similarity scores between 0.000 and 1.000, while a second list 602B may include scores between 1 and 100. A third list 602C may include no scores, but have weighting implicit in the order of items in the list. Accordingly, to properly multiplex the lists, in one embodiment, the recommendation service may translate or normalize the lists into a common format, with a common scoring mechanism.

Referring back to FIG. 4, having identified a candidate list or combined candidate list at step 600, a recommendation service 214 may add and/or remove items of media from the candidate list at step 700. In some embodiments, it may be necessary to add a seed item of media to a candidate list for the seed item of media. For example, in some embodiments, a candidate list or list of similar items of media to a seed item of media may not include the seed item of media. This may be because a seed item of media is 100% similar to itself, by definition, and accordingly is considered an uninteresting case by the providers of the similarity database, or may be due to an algorithm that generates a similarity database excluding the seed from each generated list. For example, in one such embodiment, the seed may comprise the origin for a vector within a similarity-space of items of media, with the length of the vector to a second item of media identifying how similar or dissimilar the items of media are, and the direction indicating items of media that are likewise similar to each other. As a O-length vector may be directionless, the algorithm may require at least a non-zero length in order to identify a chain of similar items of media. Accordingly, in many embodiments, the recommendation service 214 may not identify the origin item of media.

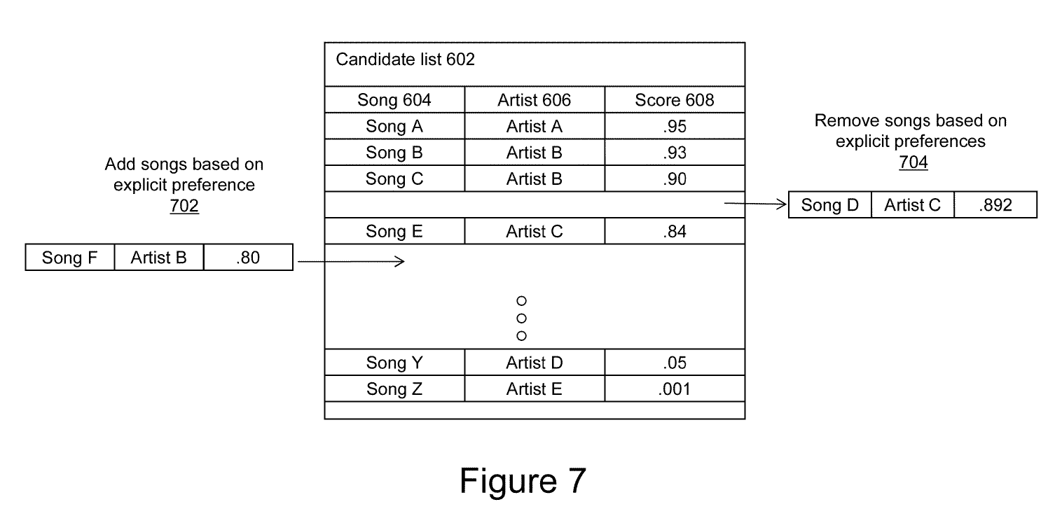

Referring briefly to FIG. 7, illustrated is a diagram illustrating adding items to the candidate list based on explicit preferences 702 and removing items based on explicit preferences 704. Although shown with the candidate list 602 of FIG. 6A, in many embodiments, the candidate list may comprise a combined candidate list, as discussed above in connection with FIG. 6B. As shown, in many embodiments, one or more items or songs may be added to the candidate list 602 responsive to explicit preferences 702. For example, a seed item of media for creating a candidate list may be considered an explicitly “liked” item of media, because the station was created responsive to the seed. In some embodiments, other “liked” items of media may be added to the candidate list 602. For example, for embodiments in which a combined candidate list is created by performing a logical AND or intersection of two lists, items of media that appear in one candidate list may be left off of the combined candidate list. However, the user may have previously indicated that they “like” one of the left off items of media. Accordingly, at step 702, the item of media may be added back into the combined candidate list.

Similarly, at step 704, items of media that the user has explicitly “disliked” or indicated a negative preference for may be removed from the candidate list or combined candidate list. For example, in some embodiments, regardless of the score 608 of an item of media, if the user has indicated they do not like an item of media, the recommendation service 214 may remove the item of media from the list to ensure that the user does not hear items of media they dislike.

In another embodiment, step 702 may be repeated to return a removed item of media to the list. For example, in some embodiments, an item of media may be removed from the list based on a user having indicated a negative preference for the item of media at a prior time. However, the user may have negatively rated the item of media months or years previously, and in the interim may have positively rated similar items of media, or items of media by the same artist. In other embodiments, the user's friends may have positively rated the item of media, resulting in it having a very high score 608. Accordingly, in some embodiments, the item of media may be returned to the candidate list, but perhaps at a significantly reduced score to cautiously allow the user to re-discover the item of media.

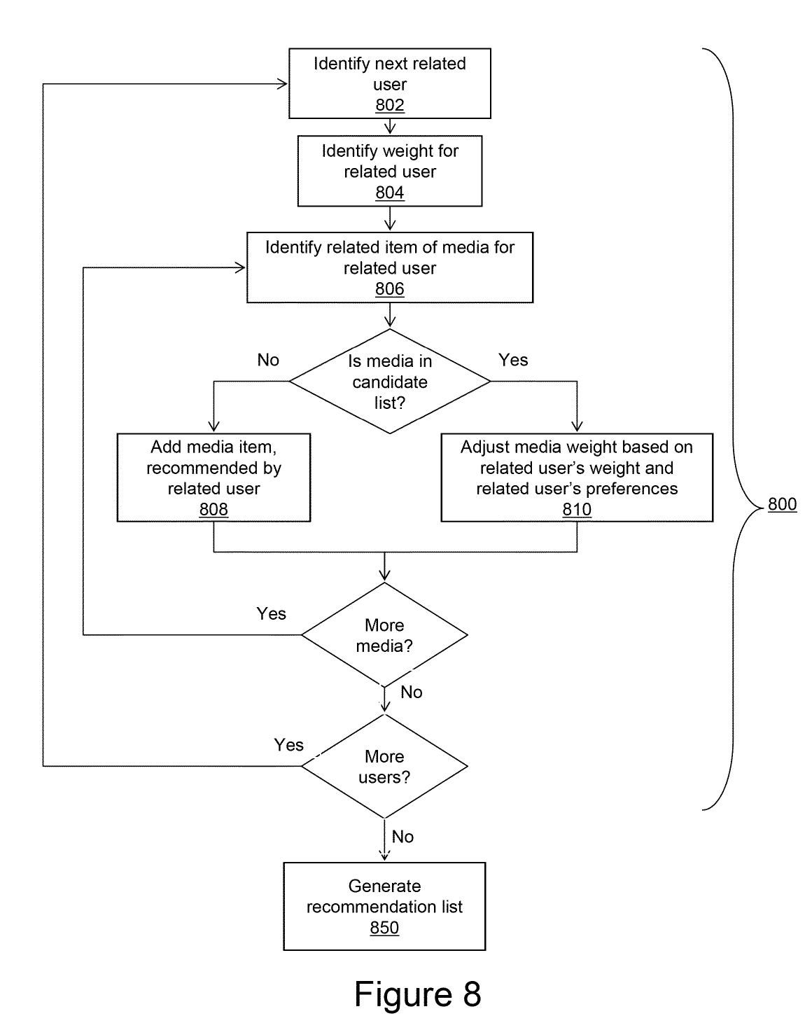

Returning briefly to FIG. 4, after adding and removing items of media from the candidate list at step 700, the recommendation service may modify media weights in the candidate list based on social relationships of the requesting user at step 800. Referring now to, FIG. 8, an embodiment of a method 800 for modifying media weights in the candidate list is illustrated in a flow chart. In brief overview, at step 802, the recommendation service may identify or select a user that is related to the first user. At step 804, the recommendation service may identify a weight for the related user. At step 806, the recommendation service may identify a related item of media for the related user. In some embodiments, the identified item of media may be in the candidate list generated at step 700, while in other embodiments, the identified item of media may not be in the candidate list. In one embodiment, responsive to the item of media not being in the candidate list, the recommendation service may add the item of media to the candidate list, identifying the item of media as recommended by the related user at step 808. If the item of media is in the candidate list, then in some embodiments at step 810, the recommendation service may adjust the item of media's weight or score within the candidate list responsive to the related user's weight or matching score, and the related user's preferences. Steps 806-810 may be repeated iteratively for each of a plurality of related items of media in the related user's preferences, and steps 802-810 may be repeated iteratively for each of a plurality of related users. At step 850, in some embodiments, the candidate list may be returned as a modified candidate list or a recommendation list to the controller for selecting one or more items of media for playback. In other embodiments, discussed in more detail below, the recommendation service may select the one or more items of media for playback from the recommendation list.

Still referring to FIG. 8, and in more detail, in one embodiment at step 802, the recommendation service may identify a second user, or related user, that is related to the first user, or requesting user, from which the seed or seeds were received, or for which the seed was retrieved or generated, at steps 410 or 550 of FIG. 4. As discussed above, in some embodiments, a related user may comprise a user related to the first user, either explicitly, such as being a friend of the first user on a social networking site, being followed by the first user, following the first user, or implicitly, such as being employees at the same company, living in the same town, or having any other trait in common. In some embodiments, identifying the second user may comprise retrieving, by the recommendation service, a list of friends, followers, followed users, colleagues, family members, or other associated users of the first user from a social networking service, and proceeding iteratively through the list of associated users. In one embodiment, the list of associated users may be ordered based on a frequency of communication between each associated user and the first user. For example, users with whom the first user regularly communicates via the social networking service may be placed higher in the ordered list. Such communications may include writing wall posts, sending public or private messages, tagging photos, playing multiplayer games, commenting on posts, “liking” posts, or any other similar interaction. In a further embodiment, to reduce processing requirements, the number of associated users in the list may be limited to a predetermined number, such as 100, 500, 50, 10, or any other number. In another further embodiment, the number of associated users in the list may be limited based on a time of recent communication, such as associated users with whom the first user has communicated with in the past day, past week, past month, or any other time period. In yet another further embodiment, the number of associated users in the list may be limited based on a frequency of communication, such as associated users with whom the first user has communicated with at least once per day, once per week, once per month, or any other rate.

At step 804, in one embodiment, the recommendation service may determine a weight, or matching score, for the related user, the weight based on degrees of similarity or similar traits between the related user and the requesting user. In some embodiments, determining a weight for the related user may comprise performing step 500 of FIG. 3C, or one or more iterations of steps 532-538 of FIG. 5C, discussed in detail above. In another embodiment where steps 532-538 have already been performed for the related user and first user, such as when the user requested to create a new station without providing a seed, the recommendation service may retrieve a previously-determined weight for the related user. As discussed above, determining a weight for the related user may comprise comparing one or more traits of the requesting user and the related user to increase or decrease a default similarity score.

At step 806, the recommendation service may identify a related item of media for the related user. In one embodiment, a related item of media may comprise an item of media in the candidate list that the related user has previously rated positively or negatively. Such items of media may have appeared in other candidate lists for generation of playlists for the related user, and the related user may have indicated that they liked or disliked various items of media as they came up in the playlist. Because the related user has been identified as similar to the requesting user, the related user's preferences may also be similar. Accordingly, if the related item of media is in the candidate list, at step 810, the related item's score or order within the list may be adjusted responsive to both the related user's preference (like or dislike), and the related user's weight or similarity to the requesting user. For example, if the related user disliked the item of media, and the related user is highly similar to the requesting user, the recommendation service may significantly reduce the score for the item of media, or even remove the item of media from the list. If, on the other hand, the related user disliked the item of media, but is only marginally similar to the requested user, then the recommendation service may only slightly reduce the score for the item of media. Similar embodiments may be used to increase the score for the item of media if the related user liked the item of media. In some embodiments, the item's score may be adjusted positively or negatively, responsive to the related user liking or disliking the item of media respectively, by a predetermined amount, proportional to the related user's weight. Accordingly, the more similar a related user is to the requesting user, the more the related user's preferences will affect the resulting modified candidate list.

In another embodiment, the recommendation service may identify a related item of media at step 806 that is not in the candidate list. For example, in one embodiment, the related item of media may be an item of media that the related user has recommended to the requesting user or dedicated to the requesting user. The item of media may have previously been in the candidate list, but been removed at step 700, as discussed above. Furthermore, as discussed above, in some embodiments, the length of a candidate list may be limited to reduce processing, such as where the candidate list comprises the 100 items of media with the highest degrees of similarity to the seed. Accordingly, the 101st item of media may still be similar or related to the seed, but not be in the candidate list. In any of these embodiments, the recommendation service may determine if the related user has rated the item of media positively or negatively. If the user has rated the item positively, then at step 808, the recommendation service may add the related item of media to the candidate list, at a predetermined score or weight proportional to the user's weight, as discussed above. Because the item was not previously in the candidate list, the predetermined score may be a relatively low score, reflecting that the item was not judged to be highly similar in the initial candidate list or lists.

In yet another embodiment, as discussed above, multiple candidate lists may be generated from different similarity databases and multiplexed to generate a single candidate list. In embodiments in which the single candidate list is a subset of the multiple candidate lists, such as an intersection or length-limited interleaving, an item of media may have been recommended on one candidate list, but not appear in the combined candidate list. In some embodiments, the recommendation service may identify the item of media and determine if the related user has previously rated the item positively. If so, then at step 808, the recommendation service may add the related item of media to the candidate list, at a predetermined score or weight proportional to the user's weight, as discussed above. In some such embodiments, the predetermined score may be based off the item's score in the initial candidate list in which it appeared.

In some embodiments, steps 806-810 may be repeated iteratively for multiple related items of media for the related user. In another embodiment, steps 802-810 may be repeated iteratively for multiple related users. Accordingly, by repeatedly adjusting, or lowering or boosting items of media in the candidate list based on social networking information and related user preferences, a modified candidate list, sometimes referred to as a recommendation list, may be generated that leverages the preferences of similar users to create a station with only media that the requesting user is likely to enjoy.

Referring back briefly to FIG. 4, having generated a recommendation list at step 850, in some embodiments, at step 900, the recommendation service may select one or more items of media from the recommendation list to play or queue in a playlist. In another embodiment, the recommendation service may return the recommendation list to a controller or media provider server, and the controller or server may select one or more items of media to play or queue in a playlist at step 900.

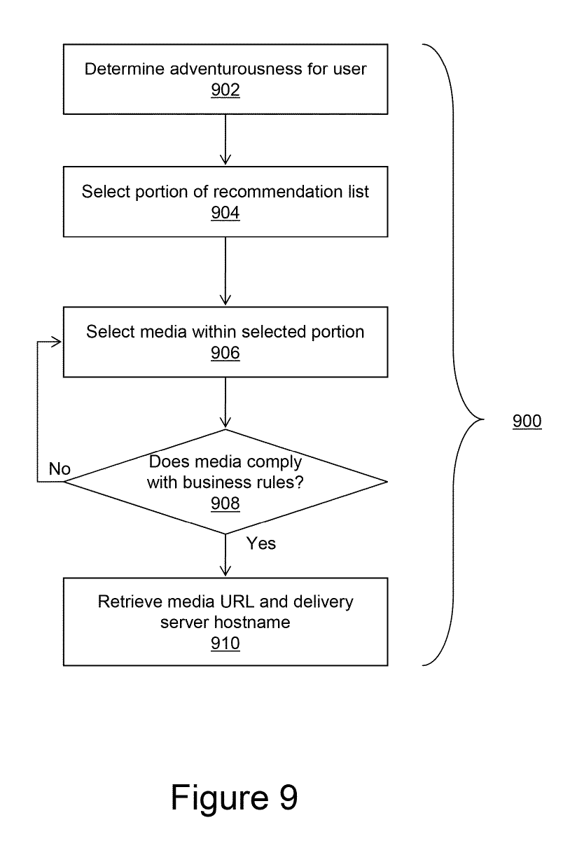

Referring briefly to FIG. 9, illustrated is a flow chart of a method 900 of selecting or queuing an item of media from a recommendation list. In brief overview, at step 902, the recommendation service or controller may determine an adventurousness of the requesting user. At step 904, responsive to the determined adventurousness, the recommendation service or controller may select a portion of the recommendation list. At step 906, the recommendation service or controller may select an item of media content within the selected portion. At step 908, the recommendation service or controller may determine if the item complies with one or more business rules or policies. If not, the recommendation service or controller may select a next item of media content within the selected portion at step 906. If so, at step 910, the recommendation service or controller may retrieve a URL for the item of media content and transmit the URL to one or more users' computing devices.

Still referring to FIG. 9 and in more detail, in one embodiment, a recommendation service or controller may determine the adventurousness of the requesting user. In one embodiment, the adventurousness of a user may represent how willing the user is to listen to items ranked lower or less similar to a seed in an ordered recommendation list. A less adventurous user may be less interested in lower ranked items, and would prefer to receive just higher ranked items. In some embodiments, the adventurousness of a user may be represented by a value stored in a user profile, while in other embodiments, the adventurousness of a user may be dynamically determined by presenting the user with a first lower ranked item and receiving either a positive preference or “like” or a negative preference or “dislike” from the user. Responsive to the user indicating a positive preference for the first lower ranked item, a second lower ranked item may be presented to the user, the second lower ranked item ranked lower in the recommendation list than the first lower ranked item. Responsive to the user indicating a negative preference for the first lower ranked item, a second item may be presented to the user, the second item ranked higher in the recommendation list than the first lower ranked item. Accordingly, the recommendation service or controller can dynamically probe the user's tolerance for items of content less similar to the seed to determine how adventurous the user is.

In one embodiment, the recommendation list may be divided up into sections, such as the first section comprising the first 20 items, the second section comprising the next 20 items, the third section comprising the further next 20 items, etc. In another embodiment, the recommendation list may be divided up into unevenly sized sections, such as the first section comprising items 1-10, the second section comprising items 11-50, the third section comprising items 51-120, etc. In still another embodiment, the recommendation list may be divided into high, middle, and low sections, responsive to similarity scores or weights. At step 904, responsive to the determined adventurousness of the user, the recommendation service or controller may select a portion of the recommendation list. Selecting a portion of the recommendation list may comprise generating a random number and selecting a portion of the list, responsive to the random number. In many embodiments, the portions of the list may be unevenly weighted, such that the recommendation service selects a first, highest ranked portion of the recommendation list most often. For example, given a random number between 1 and 100, and a recommendation list of 100 items of media with sections 1-20, 21-50, and 51-100, a recommendation service may select the highest ranked portion or 1-20 responsive to the random number being equal to or between 1-50. Similarly, the recommendation service may select the middle section, or items 21-50, responsive to the random number being equal to or between 51-80. Finally, the recommendation service may select the lowest rated section, or items 51-100, responsive to the random number being equal to or between 81-100. This uneven distribution results highly ranked or more similar items being selected more frequently than less similar items, which may reflect the user's preferences.

In one embodiment, the weights for different sections may be based on the user's adventurousness. For example, a highly adventurous user may have a less heavily weighted highly ranked section, and a more heavily weighted middle or lower ranked section of the recommendation list. Conversely, a not very adventurous user may have a more heavily weighted highly ranked section, with very low weights for middle or lower ranked sections. In one embodiment, the user's adventurousness may be represented by a value a with values between 0 and 1 representing less adventurous users, and values greater than 1 representing more adventurous users. In such an embodiment, the random number may be raised to the power of the adventurousness value a, with the result being used to select a portion of the recommendation list. Accordingly, the result for more adventurous users will tend to fall lower on the recommendation list in the less similar items, while the result for less adventurous users will tend to fall higher in the recommendation list in the more highly similar items. In other embodiments, the random numbers assigned to different sections may be unevenly distributed responsive to the user's adventurousness.

Once a section of the recommendation list is selected, at step 906, an item of media from within the section may be selected. In one embodiment, this second selection may comprise a random selection from within the section of the recommendation list. In another embodiment, the second selection may comprise a pseudorandom but non-repeating selection of items from the section, such that no item within the section is selected twice until each item is selected once. In yet another embodiment, the second selection may comprise an ordered selection from within the second of the recommendation list, proceeding iteratively through the section.

At step 908, the recommendation service or controller may determine if playing back the item of media complies with one or more business rules. Several business rules apply to streaming or otherwise-provided media, based on, for example, the Digital Millennium Copyright Act (DACCA). By complying with various business rules, including limitations based on the number of times an item of content may be played within a predetermined time period, or the number of items of content by a specific artist may be played within another predetermined time period, the media provider can take advantage of lower statutory royalties and compulsory licensing schemes. Accordingly, having selected an item of media at step 906, the recommendation service or controller may apply one or more business rules, responsive to a record of previously selected or played items of content on the station, to determine whether playing the selected item of media will violate one of the rules. If so, another item of media may be selected.

If the selected item of media does not violate a business rule, then at step 910, the controller may retrieve a URL for the item of media and a hostname or address of a media delivery server with access to the item of media. In one embodiment, the recommendation service performs selection of items of media, and transmits a playlist of one or more items of media to the controller. In a further embodiment, such playlist may comprise identifiers of the one or more items of media, such as media item identifiers or GUIDs. However, it may be unnecessary to transmit additional other information to the controller, including item weights, scores, or the entire recommendation list.

Referring back to FIG. 4, at step 920, the controller 212 may transmit a URL for the item of media to the client, so that the client may retrieve the media. In one embodiment, the controller 212 may transmit multiple URLs for a plurality of items of media to be played in sequence, allowing the client to prefetch and locally buffer the content. In some embodiments, the controller may transmit a playlist of one or more items, such as an M3U playlist, to the client. For example, in some embodiments, the media streaming server may use an HTTP live streaming protocol or similar pseudostreaming communications protocol, and may transmit a corresponding playlist for the items of media content.

At step 940, the controller may receive a request from the client for a next item of media. In one embodiment, the requested next item of media may comprise the next item of media to be played in a timeline, while in other embodiments, the requested next item of media may comprise an item of media to be played after a local buffer of one or more items of media is exhausted. For example, a client device may buffer three items of media locally. After playing the first item and while playing the second, the client device may request a fourth item of media. This allows the client to continuously fill a buffer in advance. In some embodiments, the controller may repeat steps 900-940, while in other embodiments, the controller may transmit the request for a next item of media to the recommendation service 214, which may perform step 900 and respond with a next item of media identification to the controller, which may repeat steps 920-940.

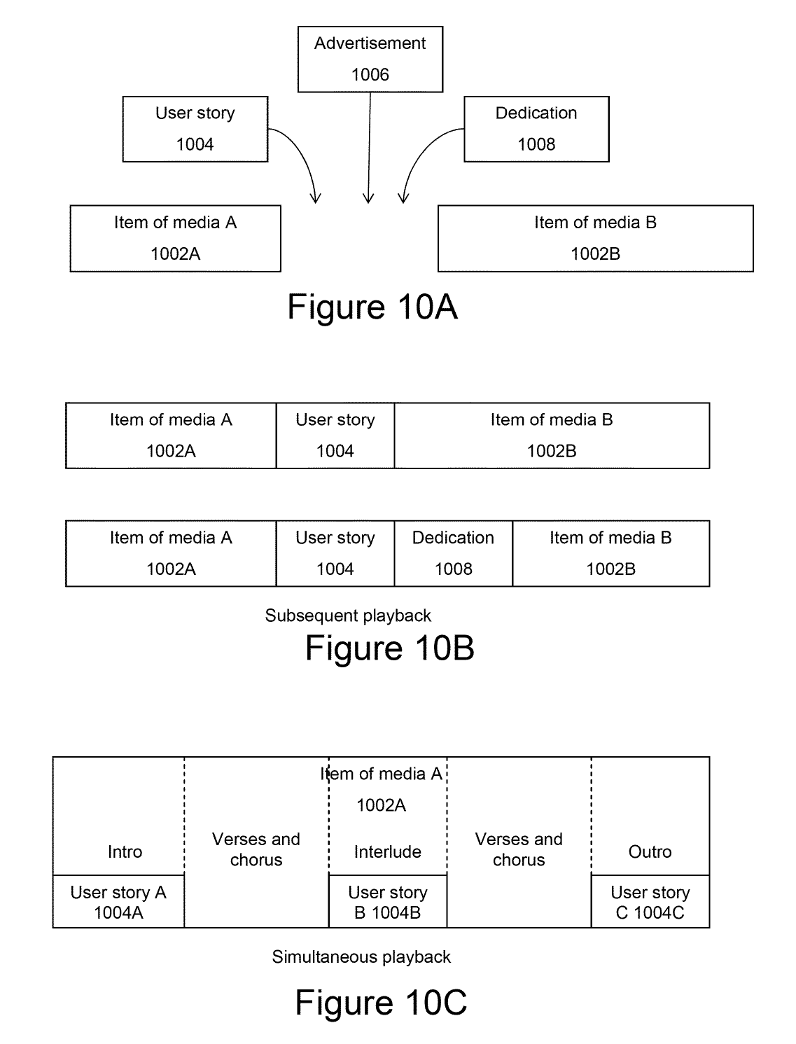

Referring briefly to FIGS. 10A-10C, in some embodiments, different items of media content may be selected for playback within the timeline or playlist. For example, in addition to items of media content such as songs, music videos, and television shows, the media provider system may be used to provide user generated content, such as user stories or dedications, as well as advertiser generated content. Advertiser generated content may comprise audio and/or video advertisements, which may be provided to users responsive to user preferences and social networking relationships, leveraging the access to social networking profiles discussed above for identifying media preferences of related users. Because the recommendation service knows a user's age, location, gender, hobbies, preferences and other information, through parsing of the user's profile, highly targeted advertisements can be delivered. In a further embodiment, the system may detect user preferences for advertisements, similar to the system detecting user preferences for items of media. For example, the media provider system may determine that a user “likes” an item of media responsive to the user rating the item up or selecting a “thumbs up” icon or similar icon. Similarly, the media provider may determine that a first user “likes” an advertisement responsive to the first user clicking on, selecting, or otherwise interacting with the advertisement. The recommendation service may then add the advertisement to playlists for similar or related users, on the grounds that being similar, the other users are also likely to “like” the advertisement. This provides social networking-based feedback, refining the targeting of the advertisements.

User stories may comprise audio, video, or text generated by a user and associated with an item of media. For example, in one embodiment, a user story may comprise a brief audio and/or video recording by a user describing what a particular song means to them. In another embodiment, a user story may comprise an audio recording by a movie director, describing why certain cinematographic decisions were made during filming of a movie. In yet another embodiment, a user story may comprise an actress describing a motivation of her character in a scene of a television show. User stories may be public, or may be restricted to related users to the user who created the user story. In some embodiments, user stories may be available on demand for playback. For example, when watching a television show or listening to a song, the client agent may display a list of related user stories received from the media provider. Each user story in the list may be associated with a corresponding URL for an item of media content, and the user may select a user story to retrieve and playback the user story. In another embodiment, user stories may be interleaved in a playback stream automatically.

Dedications may be similar to user stories, and may comprise an audio or video recording by a user, associated with an item of media, and targeted or referring to another user. In one embodiment, a dedication may be used by one user to recommend an item of media to a second user. Responsive to recording the dedication, the recommendation service may add the item of media to a station for the second user or increase the item's weight within a station of the second user. The recommendation service may further add the dedication into a playlist to be played prior to, subsequent to, or during the playback of the item of media content.

Referring now to FIG. 10A, illustrated is a block diagram of an embodiment of a timeline with an item of media A 1002A and an item of media B 1002B with a gap between them. In one embodiment, the media provider may select a user story 1004, advertisement 1006, or dedication 1008 to add to the timeline between the items of media for playback for a user connected to the station. Each user story 1004, or dedication 1008 may be selected responsive to an association with the previous or subsequent item of media 1002A-1002B. In some embodiments, multiple user stories 1004 or dedications 1008 may be inserted into the playlist, both referring to a prior item of media, a subsequent item of media, or different items of media. Advertisements 1006 may also be inserted into the playlist, and may be selected responsive to user preferences, the station seed, or any other listener demographic targeting information. For example, an advertisement for a season of a television show on DVD may be inserted into a playlist between two subsequent episodes of the television show, or two subsequent segments of an episode.

Referring briefly to FIG. 10B, in some embodiments, user stories 1004, advertisements 1006, and dedications 1008 may be inserted between items of media 1002A-1002B for subsequent playback. Conversely, referring to FIG. 10C, in some embodiments, user stories 1004, advertisements 1006, or dedications 1008 may be provided in a playlist for simultaneous playback with an item of media 1002A. For example, during a 15 second intro of a song, a brief user story from the artist about the song may be played over the intro. Similarly, during a guitar solo in the middle of the song, a user story from a friend of the user may be played, with the music slightly faded down. In one embodiment, the client agent may comprise functionality for mixing and/or cross fading between two items of media content. In another embodiment, the client agent may comprise functionality for detecting a section of an item of media content during which a user story, advertisement, or dedication may be played. For example, the client agent may scan ahead of the current playback position in an item of media content for silence, a soft section, a fade in or out, a section lacking significant energy in frequencies associated with the human voice such as 250 Hz to 2.5 kHz, a section of video with a uniform color, or any other time within the content. The client agent may determine the length of such sections, and request and/or playback user stories, dedications and/or advertisements of equal or lesser duration.

In some embodiments, to keep advertisements short and nonintrusive, advertisements 1006 may be limited in length and a banner may be displayed during a subsequent item of media 1002B associated with the advertisement 1006. This may allow a user to select or click on the banner to load a website or other material associated with the advertiser, while allowing the advertisement to be no more than a few seconds in length.

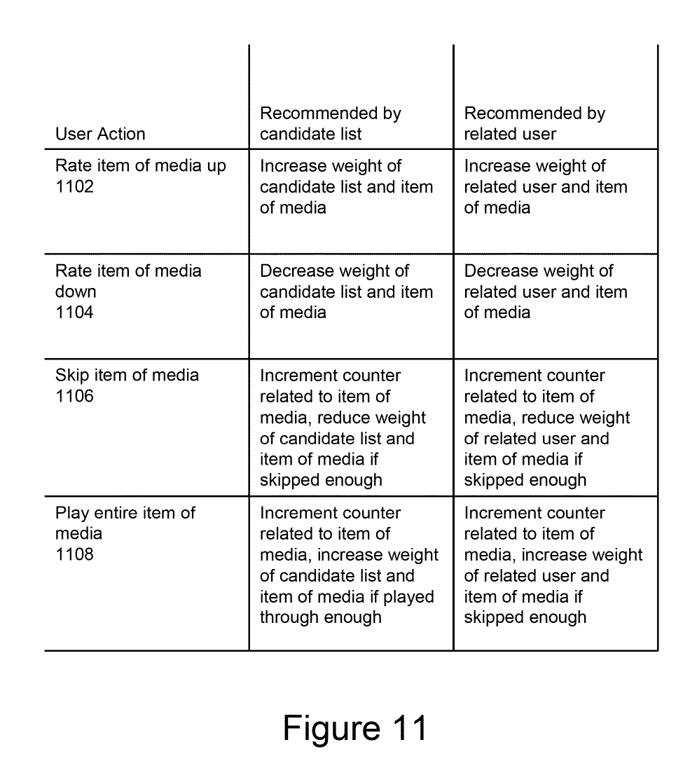

Referring now to FIG. 11, the media provider and client agent discussed above allows for a user to provide feedback regarding items of media content played for the user. For example, the user may rate an item of media content up or indicate a positive preference or that they “like” the item. The user may alternately rate an item of media content down or indicate a negative preference or that they “dislike” the item. In some embodiments, an item that is rated up may be moved up within an ordered or weighted playlist or have its score increased, such that the item may be selected more often. An item that is rated down may be moved down within the ordered or weighted playlist or have its score increased, such that the item may be selected less often. In some embodiments, an item that is rated down may be removed from the playlist entirely. The user may also skip the item of media content, or indicate that while the item should not be removed or rated down, the user does not wish to hear or watch the item at the moment. The user may also play through the entire item of media content, which may implicitly indicate that the user has a positive preference for the item.

The user's feedback may also be used to rate candidate lists and/or related users. For example, the user's feedback may be used to indicate that a first candidate list of a plurality of candidate lists that are multiplexed together is highly accurate or includes many preferred items of media content for a particular user, while a second candidate list of the plurality of candidate lists is inaccurate or includes few preferred items or many disliked items. Similarly, while the recommendation service may initially determine that a related user is moderately similar to the requesting user, the recommendation service may increase or decrease the similarity or matching score based on feedback of the requesting user to items of media content for which the related user has indicated a preference.

As shown in FIG. 11, in one embodiment, an item may be recommended by a first candidate list of a plurality of candidate lists. In some embodiments, responsive to a user rating up an item of media 1102, the recommendation service may increase a weight of the first candidate list and the item of media or increase the item's score or position within the list. Accordingly, the first candidate list may be relied on more heavily when using a weighted round robin or similar algorithm for multiplexing the candidate lists.

In another embodiment, responsive to a user rating down an item of media 1104, the recommendation service may decrease a weight of the first candidate list and the item of media or reduce the item's score or position within the list or remove the item of media from the candidate list. Accordingly, the first candidate list may be relied on less heavily when using the weighted round robin or similar algorithm for multiplexing the candidate lists.

In still another embodiment, responsive to a user skipping an item of media 1106, the recommendation service may increment a skip counter. Responsive to the skip counter exceeding a predetermined threshold, the recommendation service may decrease a weight of the first candidate list. In one embodiment, the skip counter may be specific to the item of media. In such embodiments, responsive to the skip counter exceeding a predetermined threshold, the recommendation service may decrease a weight of the item of media or decrease the item's score or position within the list.

In yet still another embodiment, responsive to a user playing an item of media through without rating the item 1108, the recommendation service may increment a play counter. Responsive to the play counter exceeding a second predetermined threshold, the recommendation service may increase a weight of the first candidate list. In one embodiment, the play counter may be specific to the item of media. In such embodiments, responsive to the play counter exceeding a second predetermined threshold, the recommendation service may increase a weight of the item of media or increase the item's score or position within the list.

The systems and methods discussed herein may be utilized to provide items of media content to users. Additionally, in some embodiments, these systems may be used to provide audio and video content simultaneously to a user or device of a user, without interrupting a flow of programming. Typically, internet radio services generally offer only audio streams of programming. Modern audiences are accustomed to having multimedia options available, which in the case of music generally means the addition of music videos.

Streaming video is generally much more expensive to provide for a service provider than streaming audio. Video generally consumes more bandwidth than audio alone, and bandwidth costs money. Video also requires more processing time and storage for servers. In some cases, video may require special licenses for the streaming technology employed. Content licensing costs are also generally more expensive than for audio streaming. Additionally, there may be no compulsory license available for streaming music videos as there is for streaming audio-only internet radio under the DMCA or similar statutes. It is for many of these reasons that typical internet radio services offer only audio.

Consumers may not always want to watch music videos associated with their music listening experience. Consuming music video requires greater bandwidth, which is often paid for by consumers by the megabyte (especially on smart phones) and so may be expensive, or be perceived as expensive, to the consumer. Watching music video is also processor intensive, and may rapidly decrease battery life in battery operated clients. Extensive processor use may also heat up a smart phone to the point of physical discomfort for a consumer, especially if the device is held in their hand or stowed in a pocket. Video may also interfere with other tasks that a consumer wants to accomplish on a smart phone, desktop computer, or other client device. Accordingly, there are various reasons and use cases during which a consumer may want an audio-only experience without music video, even if a music video is available.

Because streaming video generally costs more than streaming audio, a service that offers streaming video must find some way to support the higher costs. In an ad-supported model, this generally entails the addition of advertising inventory associated with the video, for example pre-roll, post-roll, overlays, and so forth. This advertising inventory can be sold to advertisers who will pay money in order to have consumers view their advertisements. Other services may use a premium model, where consumers pay on a per-view or monthly subscription basis.

One problem with ad-supported music videos is that consumers are not always watching the video associated with the music. The consumer may simply have the music video playing, but are only listening, for example with headphones connected to a smart phone client that is in the consumer's pocket. In this case, the consumer will not be fully interacting with the advertising being employed to pay for the music video, and therefore the advertising may not be effective enough for advertisers to buy it at rates that support the service. In a service like internet radio, video is often desirable to consumers, but not necessary for them to use and enjoy it. In an ad-supported model, if consumers don't actually use the video portion of the stream, the cost of the service is far higher than the cost of a comparable audio-only internet radio service.

Accordingly, the systems and methods discussed here in may be used to provide an internet radio service that provides both the service and the consumer with the ability to dynamically enable and disable video during playback. In some embodiments, the consumer or user may initially begin listening to internet radio in audio-only mode. Whenever the user chooses, they may dynamically enable the video portion of the service by, in some embodiments, pressing a button or tilting their smart phone in a predefined manner. The video layer may then be dynamically added to the experience without interrupting the audio entertainment stream. If the user chooses to disable video, this may also happen without interrupting the entertainment stream. In this manner, the consumer can enable video only when desired, and the service can ensure that when video playback is enabled there is an interactive user who will be exposed to advertising associated with the video.

Previous services have offered users a choice between audio-only internet radio and on-demand music video playback. These services suffer from several disadvantages when compared with the systems and methods discussed herein Specifically, they do not allow a user to switch into video mode spontaneously when, for example, the user hears a song for which they are particularly interested in seeing the video. For example, in existing systems, a user may listen to a song and decide they want to watch a corresponding video for the song. Previously, the user would have to load the video separately, frequently via a video streaming service such as YouTube of San Bruno, Calif., or Vevo, provided by Universal Music Group and others. As the user may be using a different audio provider, such as Pandora or Last.fm, this results in the user having to pause the audio playback and search for the video. The user may retrieve the video, which may start playing back at the beginning of the song, regardless of where the user was in the audio playback of the song. Finally, having watched the video, the user may resume the audio playback, which may still be playing the song. Accordingly, the user will frequently have to initiate a skip function. Not only may this skip function lower the frequency with which they hear the song, the system may not recognize or be able to account for the user viewing the video for the song. Thus, even though the user preferred the song strongly enough to wish to watch the video, this preference may be lost.

The service itself may also dynamically enable/disable video based on its ability to know when and whether the consumer is currently in an ‘interactive’ mode where they are likely to experience video advertising as desired by the advertisers. For example, the service could disable music video when it detects that it is being played back on a phone whose display has been turned off. It could require the user to touch a button every x minutes to indicate they are currently interactive, and if the button is not pressed, video would be disabled. In this manner, the service can avoid streaming video when it is unlikely that the video is being watched by the consumer.

Accordingly, in one embodiment, a client agent may provide the capability for playback of audio and simultaneous playback of video, or playback of just the audio. In some embodiments, at a time t during playback of a song, the user may select to view the video. The video may be displayed, starting at time t or shortly after, automatically synchronized with the audio. In one embodiment, the user may explicitly select to view the video, such as by touching or selecting a view video button. In another embodiment, the user may rotate a portable device from portrait mode to widescreen mode, with playback of video being triggered by rotation to widescreen mode. Similarly, the user may return to audio-only mode, either via an explicit selection of a button, rotation of the device to portrait mode, or by the screen of the device being shut off via a lock button or timeout, or, for example, an iPad or other tablet computer cover being closed.

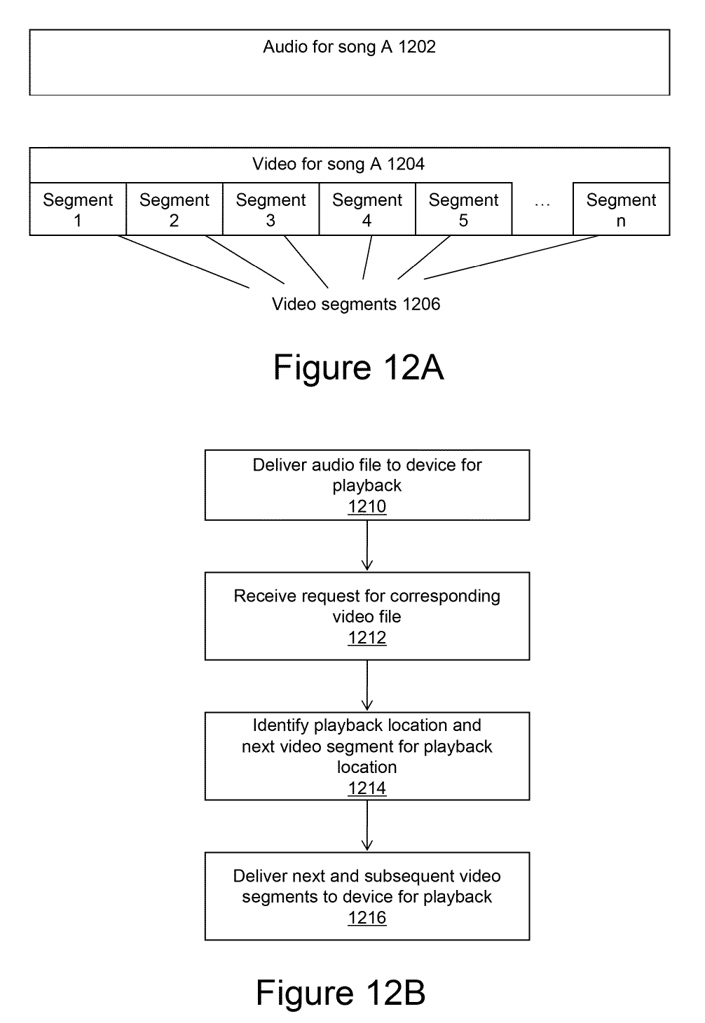

In some embodiments and illustrated in diagrammatic view in FIG. 12A, a controller may deliver a list of one or more URLs for audio files 1202 of a playlist as discussed above, and, for each audio file 1202 in the list of URLs, may deliver an extended playlist 1204 of video slices or segments 1206 for playback via a HTTP Live Streaming (HLS) or pseudostreaming protocol. HLS and similar protocols slice a video file into a sequence of small segments of, for example, ten seconds or twenty seconds or five seconds or any other duration in length. These files or segments 1206 may be transferred individually and quickly as file downloads, taking advantage of HTTP file transfer optimizations within a network. The recipient may assemble the files and play them back, and if download speeds are faster than the data rate of the video, may play the files back in essentially real-time, after a short delay to fill a buffer.

While playing the audio file 1202, the client agent knows the current playback time t. Accordingly, when the user requests to view the video 1204 at, for example, 43 seconds into a song, the client agent may identify a next segment 1206 in the list of video segments of the song and request download of the segment 1206 and subsequent segments 1206. For example, if the segments are 10 seconds in length, then the client agent may request the segment starting at 50 seconds into the song, and all subsequent segments. The client agent may receive and buffer the files, and start playing the first segment 7 seconds after the request at 50 seconds into the song, in synchronization with the audio. In embodiments using slower networks, the client agent may request a segment at a point far enough ahead in playback of the audio to receive and playback the segment in time and buffer additional segments. Accordingly, the user may seamlessly switch between audio-only and audio and video modes, without interrupting playback.

Referring now to FIG. 12B, and in brief overview, the steps taken in one embodiment of the system to deliver and display video on demand in synchronization with currently playing audio are illustrated in a flow chart. An audio file may be delivered for playback at step 1210. In some embodiments, a playlist of video segments comprising a video file and corresponding URLs for each segment may be delivered to the client. The client agent may receive a request from the user to initiate playback of the video file corresponding to the audio file at step 1212. At step 1214, the client agent may identify a current playback location in the audio file and a next video segment from the current playback location. At step 1216, the client agent may transmit a request to a media server for delivery of the identified next video segment and subsequent video segments of the video playlist.

Still referring to FIG. 12B, and in greater detail, audio media is delivered for playback at step 1210 using any one of the methods described above. For example, in one embodiment, a controller may transmit a URL of an audio file to a client agent, which may request the audio file from a media server. In some embodiments, the controller may also transmit a series of URLs of video file segments 1206 corresponding to the audio file, or may transmit the series of URLs as an M3U playlist or similar playlist. In other embodiments, the controller may transmit the series of URLs with video file segments 1206 responsive to a request from the client device for the video file URLs or for a video file associated with the audio media. In some embodiments, the request may include information about the client device 200 such as screen size or screen resolution or preferred video format or data rate, and the controller may transmit a series of URLs with video file segments 1206 transcoded or produced for playback at the specified size, resolution, format, or data rate. In other embodiments, the controller 212 may collect additional information associated with the request such as the type of connection over which the request was received (IP, CDMA, GSM, etc.) or the origination location of the request.

At step 1212, during playback of the audio media, the user may indicate a desire to switch to view the video media. In some embodiments this may be done by selecting a soft button or control on a web page displayed in a browser. For embodiments in which the client device 200 includes an accelerometer, the user may indicate the desire to switch streams by shaking the client device 200 or by rotating the client device 200 a predetermined number of degrees in a predetermined plane of rotation. In still other embodiments, the user may indicate this desire by using a gesture on the touch screen of the client device 200.

At step 1214, in some embodiments, the client agent may identify a current playback location in the audio file, responsive to receiving the request or identifying the user's desire to switch to view the video media. In some embodiments, the client agent may identify the current playback location as an absolute timestamp while in other embodiments the client agent may identify the current playback location as a value relative to a prior point in the file. In some embodiments, the client agent may identify a video segment in the playlist of video segments having a start time that is near the identified current playback location. In some embodiments the client agent may identify a video segment with a start time a sufficient amount beyond the current playback location to account for transmission delays. In other embodiments the client agent may identify a video segment with the lowest start time that is greater than the current playback location.

At step 1216, the client agent may retrieve a URL address associated with the identified video segment in the playlist, and transmit a request for the video file at the URL address to a media server. In some embodiments, the client agent may transmit multiple requests or one request for multiple files, to request the identified video segment and successive video segments in the video playlist.

Although discussed above in terms of embodiments where the client agent has the video playlist in advance of the user request to view the video, in other embodiments, the client agent may not have the video playlist in advance. In such embodiments, the client agent may determine or identify a current playback time of the audio file, and transmit a request to a controller 212 for the video segments, the request comprising the current playback time. In some embodiments, the request may further comprise parameters of the device, such as a preferred resolution or screen size or format, or network parameters such as latency, data rate, or other identifiers. The controller 212 may identify the next video segment, as at step 1214 above, and may transmit a URL or playlist of URLs for the next video segment and/or successive video segments to the client agent. The client agent may then transmit a request or multiple requests for the video segments to the media server.

When the client agent 202 receives the initial video segment, it may begin playback of the video media along with playback of the audio media. In some embodiments, the video media may include an audio soundtrack. In such embodiments, the client agent may stop playback of the audio file and begin playback of the video file with the audio soundtrack. In some embodiments, the client agent 202 may delay starting the playback of the received video media in order to synchronize video and audio playback. In still other embodiments the client agent may cross fade the audio of the audio file and audio of a soundtrack of the video.

As discussed above, by identifying a current time of audio playback, the client agent may seamless switch between playback of an associated video and an audio-only mode, without needing to restart playback of the audio. A similar method and system can be used to extend the single-listener station model to a multi-listener, collaborative or shared station, incorporating social listening and interaction. While previous internet radio models have been either non-customizable multicast streams, or customizable unicast streams, by maintaining a timer and transmitting commands to start playback in the middle of an audio file, similar to playback of a video file discussed above, multiple users may listen to a customizable playlist simultaneously. The multiple users may vote media up or down in collaboration, leave comments for each other, discuss the media, or interact in other ways. Thus, rather than models approximating radio or television broadcast where users passively consume media, or models approximating a user listening to a random collection of compact discs, the systems and methods discussed herein allow a model approximating a group of friends sitting together, listening to each other's CDs or watching DVDs or third-party streamed media, discussing the media together, voting to change channels or skip to a next song, and otherwise provide a more social, interactive environment for consuming media.

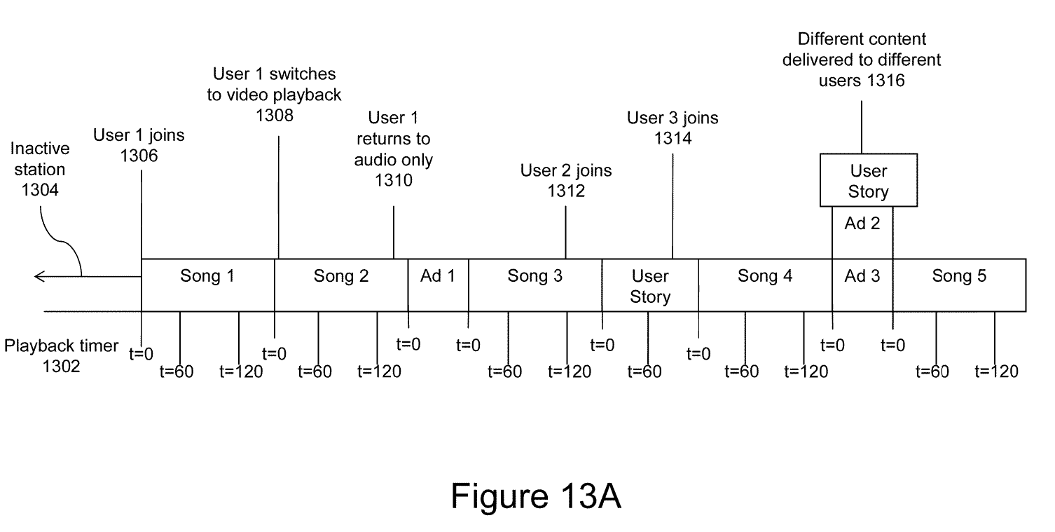

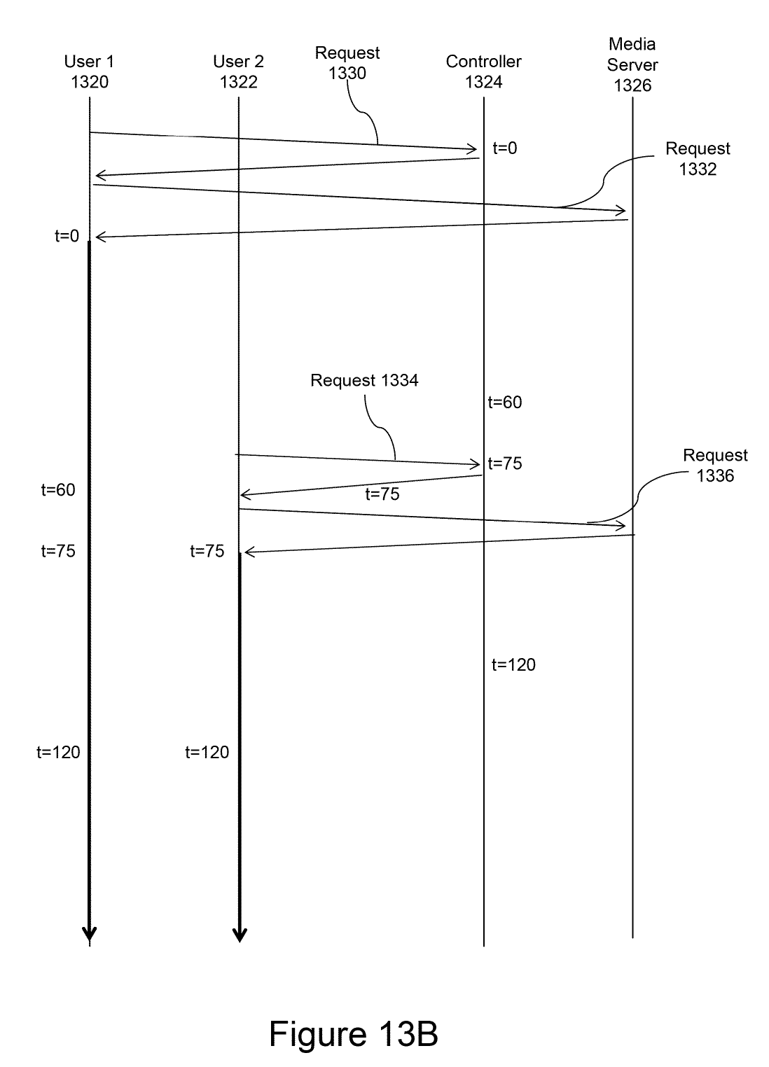

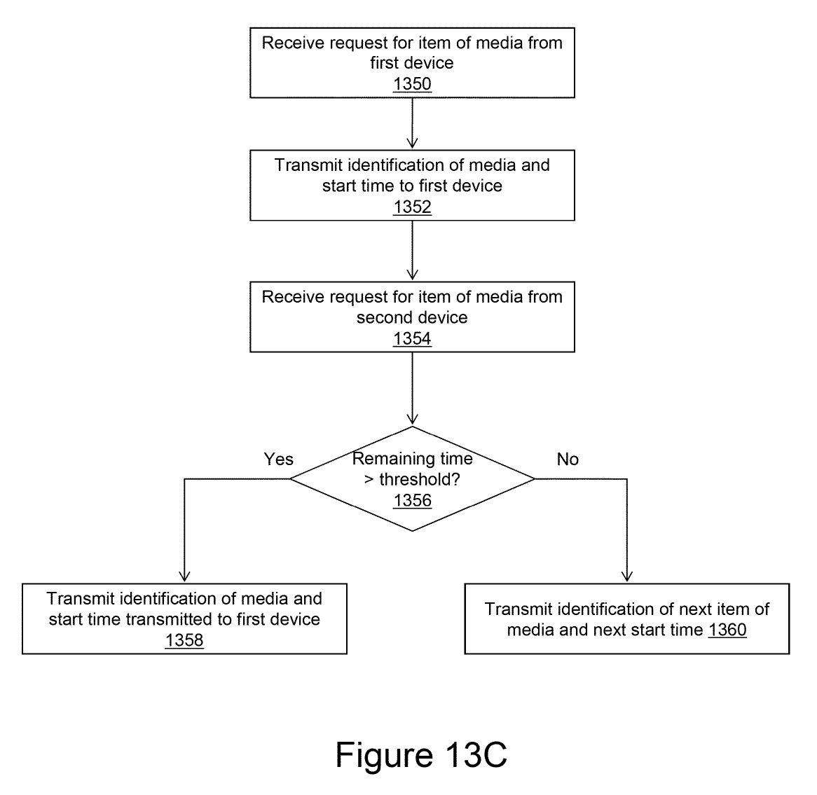

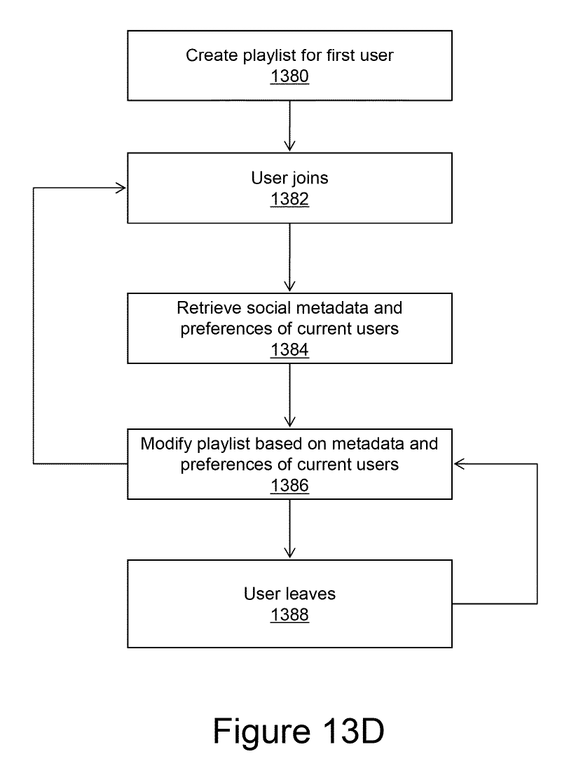

Referring now to FIG. 13A, illustrated is a timeline view of an embodiment of a playlist for shared listening of a station. At 1304, the station is inactive, as no listeners are currently connected to the station. Although created, with a seed in a station database, no media from the station is being played, and the controller does not need to maintain a timer or playlist. In other embodiments, the station may be not yet created, but created by a first user, as discussed above.

At 1306, a first user may join or create the station. When the controller delivers a playlist of one or more URLs for media to the first user, the controller may start a local playback timer 1302 for the station. Playback timer 1302 is similar to a playback timer maintained by the client to allow switching between audio and audio/video playback modes, as discussed above. Playback timer 1302 may, in some embodiments, be reset at the beginning of playback of each file, and may comprise a timer of playback within a media file. In many embodiments, the controller does not need to actually play the media file to maintain the playback timer 1302. Instead, the controller may determine the length of the media file, and initiate a timer to be reset at the end time of the media file.

At 1308, as discussed above, the first user may switch to a combined audio/video mode, using a local timer on the first user's device, or by transmitting a request for a video file to the controller. In embodiments utilizing the latter technique, the controller may determine a current playback time from playback timer 1302, identify a next video segment, and transmit a playlist of the next video segment URL and subsequent video segment URLs to the first user's device for requesting from a media server. At 1310, the user may return to audio only mode, as discussed above.

At 1312, a second user may join the station. The second user may join the station by searching for or identifying the station in a list provided to the client, discussed above, and selecting to join the station in group listening mode. In one embodiment, selecting to join a station that is currently active or playing media to another user indicates to join the station in group listening mode. In other embodiments, the second user may select to join the station in group listening mode, or join the station in solo listening mode. In solo listening mode, a separate playlist may be generated for the second user without a shared timeline. In embodiments in which the second user joins in group listening mode, the controller may deliver a playlist identifying the URL for the current media file and the current playback timer value 1302. When the second user's device receives the media file from the media server, the device may start playback at the time identified by the current playback timer value. Accordingly, the second user may join the stream approximately synchronized with the first user, accounting for different network and processing latencies. Such latencies may be less than a second, or just a few seconds, negligible over the course of a multi-minute song or half-hour television show.

Similarly, at 1314, a third user may join the station. As with the second user, the third user may receive from the controller a URL for the current media file and the current playback timer value 1302. The third user's device may receive the current media file and initiate playback at the indicated time, and likewise join in approximate synchronization with the first and second users.

In many embodiments, the client agent and media provider may provide opportunities for the first, second and third users to interact while viewing or listening to the shared media. For example, the users may send text messages to each other about the current song, may discuss the song in a chat room, may discuss the song in a simultaneous video or audio chat, rate the song up or down, or otherwise interact with the song.

As discussed above, in many embodiments, the controller may insert advertisements, user stories or dedications into the playlist. To maintain synchronization, in some embodiments, the same content may be delivered to each user. However, in other embodiments, the controller may leverage the additional profile information provided to the recommendation service about each user to provide targeted advertisements or user stories. To maintain synchronization, in some embodiments, content of the same length may be provided to users. For example, at 1316, a first ad, ad 3, may be added to a playlist for a first user. A second ad, ad 2, may be added to a playlist for the second user, with the first ad and second ad being the same length. Accordingly, because the ads are the same length, the first and second user may complete playback of their respective ads at approximately the same time and begin playing the next media file in the playlist.

In another embodiment, content of different lengths may be delivered to different users. For example, as shown, a user story of a longer length may be added to a playlist for a third user. To maintain synchronization, the user story may be set to begin playback during the end of the previous media file or continue during the beginning of the next media file, and the client agent may mix or cross fade between the media files and the user story. For example, while the first user views a 15 second advertisement, the third user may hear a 25 second user story from a friend, with 5 seconds at the beginning and end overlapping with the end of the previous media file and beginning of the next media file.

Referring now to FIG. 3B, illustrated is a signal flow diagram of an embodiment of group listening for a customized station. A device of a first user 1320 may transmit a request 1330 to a controller 1324 for a playlist. In some embodiments, the controller 1324 may retrieve a playlist or receive a playlist from a recommendation service, as discussed above. The playlist may comprise URLs for one or more items of media to be played. In some embodiments, the playlist may also include an M3U playlist or similar playlist of URLs of video segments to be played simultaneously or on demand with audio files. In some embodiments, controller 1324 may start a local playback timer, as discussed above. The playback timer may expire at a time equal to the duration of the first item of media to be played, and upon expiration, may be reset with a time equal to the duration of the second item of media to be played. Controller 1324 may transmit the playlist or playlists to the device of the first user 1320. In some embodiments, responsive to a request to join a station, the controller 1324 may add the first user to a database of current users listening to or watching the station. The controller may maintain this list to determine which users to send event notifications related to the station to, or for generating advertising targeted to a plurality of users watching or listening to the station.

Upon receipt of the playlist, the device of the first user 1320 may transmit a request 1332 to a media server 1326 for the first item of media. In some embodiments, the request 1332 may comprise an HTTP GET request for one or more media files. In some embodiments, the request 1332 may specify one or more of a format, such as MP3, AAC, MP4, H.264 or any other format; a data rate, such as 64 kbps, 128 kbps, 324 kbps, or any other data rate; a resolution, such as 320×480 or 960×640 or any other resolution; or any other parameters. In some embodiments, the request 1332 may specify one or more network acceleration techniques that a client agent of the client device may use, including compression, TCP pooling or multiplexing, or other techniques. Media server 1326 may transmit the requested file to the device of the first user 1320, which may initiate playback and start a local playback timer. As shown, controller 1324's local playback timer may be offset from the playback timer of the device of the first user 1320, responsive to network delays and processing time.

In some embodiments, while the device of the first user 1320 is playing back the first item of media, a device of a second user 1322 may transmit a request 1334 to controller 1324 to join the station. The request may include the station identifier and may include an indication that the second user wishes to join in group listening mode. As with request 1330, the controller 1324 may respond to request 1334 with a playlist of URLs for the currently playing media file, and, in some embodiments, one or more subsequent media files, corresponding video playlists or segments, or other information. Controller 1324 may further include in the response a value for controller 1324's local playback timer. As shown, in an embodiment in which controller 1324 responds at time t=75 seconds on local playback timer, the response may include this value to indicate that the device of the second user 1322 should start playing the first media file at time t=75. As discussed above, responsive to receiving request 1334, the controller 1324 may add the second user to a database of users watching or listening to the station. In some embodiments, if a user leaves the station, the client agent of the user may send an event notification to the controller 1324 indicating the user is no longer watching or listening to the station. In other embodiments, the client agent may periodically query the client agents to determine if the user is still watching or listening to the station. If a client agent fails to respond, because, for example, the user has quit the client application or lost internet connectivity, the controller 1324 may remove the user from the list of users currently connected to the station. Accordingly, the controller 1324 may know at all times which users are associated with the group joined to the station.

The device of the second user 1322 may transmit a request 1336 to the media server 1326 for the first item of media. In some embodiments, similar to request 1332, the request 1336 may comprise an HTTP GET request for one or more media files. In some embodiments, the request 1336 may specify one or more of a format, such as MP3, AAC, MP4, H.264 or any other format; a data rate, such as 64 kbps, 128 kbps, 324 kbps, or any other data rate; a resolution, such as 320×480 or 960×640 or any other resolution; or any other parameters. In some embodiments, the request 1336 may specify one or more network acceleration techniques that a client agent of the client device may use, including compression, TCP pooling or multiplexing, or other techniques. Request 1336 may be similar to request 1332, or may specify different options. For example, the first device may be an Apple iPhone and request an MP4 audio file, and the second device may be an Android smart phone and request an MP3 audio file. Media server 1326 may transmit the requested file to the device of the second user 1322, which may initiate playback at the time indicated by the response to request 1334 and start a local playback timer at the identified time. In the embodiment shown, because network latencies and processing times between the device of the first user 1320 and device of the second user 1322 may be roughly equal, playback on the device of the second user 1322 may be approximately synchronized with playback on the device of the first user 1320.

In some embodiments, instead of or in addition to a playback timer reset per song, a current time stamp may be used to identify start times and playback times. For example, the controller may respond to a request 1330 with an indication of a current time (e.g. 12:00:00 PM) and a playback time for the media (e.g. 12:00:00 PM, or a subsequent time to allow time for buffering, such as 12:00:10 PM). The controller may then respond to a request 1334 with the current time (e.g. 12:01:15 PM) and the playback time for the media provided to the first user (e.g. 12:00:00 PM), implicitly identifying a current time within the media (e.g. t=75 seconds). Such embodiments may not require a playback timer or transmission of a timer value, instead simply using a current timestamp and a logged playback timestamp for the item of media. Time zone differences may be corrected with the controller adjusting timestamps according to location of the user, or may be ignored. For example, the device of the user may calculate start times within the media based off the difference between the playback timestamp and the current timestamp provided by the controller, and thus not need a local clock to be in synchronization with the clock of the controller.

Additionally, utilizing a current timestamp and a playback start timestamp allows for pre-buffering of subsequent items of media and/or preventing downloading of items of media that are almost ending. For example, if a second user joins a station or group 15 seconds before a song ends, it may be pointless to have the second user's device connect to a media server and start buffering a song, only to play the final second or two of the song. Instead, the controller may direct the second user's device to request a subsequent item of media in the playlist and provide a current timestamp (e.g. 12:05:00) and a playback start time for the next item (e.g. 12:05:15). The device may pre-buffer the subsequent item and be ready to start in synchronization with other users' devices. The controller may maintain a time threshold and compare the remaining duration of an item of media to the threshold to determine whether to transmit the identification of the current item of media or the identification of the subsequent item of media.

FIG. 13C illustrates a method for playlist generation and modification and media selection based on social metadata and user preferences. A controller may receive a request for an item of media from a first device at step 1350. The request may include an explicit identification of an item of media, such as a song or video, or may request a next item of media from a playlist as discussed above. In such embodiments, the media controller may select an item of media from a customized media playlist.

At step 1352, the controller may transmit an identification of the item of media and a playback start time for the item of media. The playback start time may be provided via a playback start timer reset for each item of media, and/or may be provided via a current timestamp and a playback timestamp. As discussed above, the identification of the item of media may include a URL or address of the item of media at a media server, or similar identifier to allow the device to download or stream the item of media. The controller may store a playback start time for the item of media, such as in a log, cache, or buffer, or may reset a timer as discussed above.

At step 1354, the controller may receive a second request from a second device for an item of media. The request may explicitly identify the item of media identified for the first device at step 1352, may be a request for a current and/or next item of media for a group, station, or room associated with the first user, or may be a request that identifies the first user (e.g. a request to listen to whatever the first user is listening to).

At step 1356, the controller may identify a remaining duration or time of the item of media. The controller may identify the remaining time based on a countdown timer or count up timer and the duration of the media, or may identify the remaining time based on the current time and the playback start time for the item of media and the duration. For example, if the current time is 12:03:00 and playback of a four minute video started at 12:00:00, the controller may determine that one minute of the video remains to be played. The controller may compare the identified remaining duration or time to a threshold, which may be predetermined or dynamically determined based on network congestion or response time of a media server.

If the remaining time is greater than the threshold amount, then at step 1358, the controller may transmit to the second device an identification of the media and the start time transmitted to the first device at step 1352. As discussed above, the identification of the start time may be implicit via a timer value, or may be explicit and may further identify a current time such that the device may identify an offset point or time in the media to begin playback.

If the remaining time is less than the threshold amount, then at step 1360, the controller may transmit to the second device an identification of a next or subsequent item of media in the playlist and a next start time. The next start time may be identified based on the time at which the currently playing item of media ends.

Accordingly, through the methods and systems described above, multiple users may simultaneously connect to and listen or view media of a customized station. Furthermore, in some embodiments, the users may collaborate on preferences for media on the station. In one embodiment, a first user of the station or user that created the station may be designated as the “master” user. In such embodiments, the first user may rate items of media up or down or skip ahead. Upon each interaction by the user, the user's client agent may transmit an event notification to the controller, which may transmit the event notification to the various other users' devices. Thus, when the master user rates an item of media up, the other users will see the corresponding thumb up or other indicator. Alternately, when the master user rates an item of media down or skips the item, the controller may transmit an event notification to the other users' devices to stop playing the current item of media and immediately start playing the next item of media in the playlists, request additional items as necessary, and reset local playback timers. In some embodiments, the controller may also transmit the event notification to the master user's device, which may skip to the next item of media in response.

In other embodiments, the station may be rated or controlled collaboratively or democratically. For example, rather than a “master” user, all users may individually rate items of media up or down or vote to skip the item of media. Each user's client agent may transmit a corresponding event notification to the controller, indicating whether the user rated the item of media up, whether the user rated the item of media down, whether the user voted to skip the item of media, whether the user added a user story or text message to the item of media, or performs other interactions with the item of media. Unlike a single user listening model, however, an individual user's rating down of an item of media or selection to skip the item of media may not cause the user's client agent to immediately play the next item of media, because this would result in desynchronizing the user's client from the other users listening to the station. Accordingly, in some embodiments, the controller may keep track of how many users of a plurality of users have rated a currently playing item of media down or voted to skip the item of media. In one embodiment, if a predetermined number of users have voted to skip or rated the item down, the controller may send an event notification to each users' client agent to immediately play the next item of media. The predetermined number of users may be a number, such as five users, or may be a percentage of the number of users currently listening to or watching the station such as 51%, 66%, 33%, 10%, or any other number. In some cases, voting may operate on a majority basis, with greater than 50% of users voting down an item of media or voting to skip before the controller sends the event notification. However, in such cases, up to half of the audience may dislike an item of media before it is skipped, potentially annoying a large portion of the users. Accordingly, in many embodiments, a smaller number of users may be required to vote to skip an item, such as 25% or 33%.

In another embodiment, a user may vote to skip an item and a request may be sent to other users in the group or station to confirm, or veto or cancel the skip within a predetermined time period, such as 10 seconds. This may be helpful in instances in which a user is listening to audio, but does not have the application in the foreground and may not recognize skip requests made by other users, or if a user is temporarily away from his or her computing device.

Similarly, a user may also vote to rate an item up. In some embodiments, the controller may keep track of the number of users that have voted the item up. Although voting an item up does not result in immediately moving to the next item of media, the controller may nonetheless keep track of the number of positive votes so that the recommendation list for the station may be dynamically adjusted responsive to user preferences of the group. As discussed above, the controller may keep track of the number of users and, responsive to a predetermined number or percentage of users rating an item of media up, may adjust the item's weight within the recommendation list.

In one embodiment, each user's client agent may display a positive or negative preference meter for the item of media, representing the percentage of users that have rated the item positively or negatively. As each user rates the item up or down, the controller may send an event notification to each client agent to move a corresponding indicator on the meter towards the positive or negative end of the scale. This may allow users to see how close an item is to being skipped or removed from the playlist.

In some embodiments, the controller may separately keep track of each user's individual preferences, even though they are listening to a group station. For example, if a user rates an item of media downwards, but is the only user to do so, the item will not be skipped or removed from the group station. Nonetheless, the controller may record the user's indicated negative preference for the item of media and, if the user joins the station in single user mode, may weight the item lower or remove the item from the recommendation list.

Although discussed above in terms of users connecting to stations generated by seeds, in one embodiment, a station may be created responsive to a mood of a user. For example, rather than identifying a seed, the user may identify a current mood, such as “aggressive” or “happy”. The recommendation engine may use the mood to identify a matching seed and generate a recommendation list. In embodiments using group listening, a mood for a station may be determined dynamically responsive to users connected to the station. For example, a first user may be identified as “happy” and a second user may be identified as “bluesy”. Accordingly, a recommendation list may be generated with upbeat blues-based songs, such as Elvis or Count Basie.

As discussed above, in some embodiments, the methods and systems discussed herein may be used to provide customized group interaction and playlist generation responsive to user preferences. Also, as discussed above, in some embodiments, the systems may incorporate content of a user on a media database of the user local to the user's device, such as an iTunes database or Windows Media database. In a further embodiment, these systems and methods can be combined, providing a music sharing party experience. Such systems may not require any streaming of media, but rather use an intersection of a plurality of users' media databases. For example, if a first user and second user each have the same 100 songs in their media databases, the controller and recommendation service may generate a playlist using these 100 songs, and provide playlists to each user's device referencing local files. As discussed above, each user's device may play the same media simultaneously, and using the client agent, each user may thumb up or thumb down items of media, discuss the media via a chat room or similar interaction, or perform other social interactions. In some embodiments, additional content, such as advertising or user stories may be added to the playlist, with the additional content delivered from a media server. In other embodiments, such as where a first user of a plurality of users does not have an item of media content that the other users of the plurality of users have, while the item is being played to the other users, the first user may be offered an opportunity to immediately purchase and download the item of media. Accordingly, the social interaction and simultaneous delivery systems described herein may be layered on top of a user's existing media database, providing social networking even for systems that were not designed for multiple simultaneous device interaction.

In addition, playlists for a group or station may be modified responsive to preferences and/or social metadata of users within the group. For example, FIG. 13D illustrates a method for playlist generation and modification and media selection based on social metadata and user preferences. As discussed above, at step 1380, a playlist may be generated for a first user based off a seed, which may be selected, extracted, or otherwise generated using any of the methods discussed herein. The first user may be considered the “owner” or creator of the station. In some embodiments, only the owner of a station may add, delete, or modify seeds.

When a user joins the station or group listening environment at step 1382, the media provider may retrieve social metadata and preferences for the user from a social networking site and/or from internal records about the user at step 1384. For example, the user may have “liked” an artist on Facebook, or may have rated an artist negatively when previously presented to the user by the media provider. Similarly, using the methods discussed above, likely preferences for the user may be generated from social network metadata such as relationships to other users with explicit preferences. In many embodiments, the user joining at step 1382 may be the first user or the station owner, while in other embodiments, the first user may already have joined the station and a second user may join. In still other embodiments, the station owner need not ever join the station. For example, a station may be created by an artist to highlight their work, but they may not necessarily ever join the station. Accordingly, the user joining at 1382 may be a first user to actually join the station.

At step 1386, the playlist may be modified based on the additional user's preferences or metadata. For example, an artist, song, video, or album may be removed from the playlist responsive to the user having indicated a negative preference for the media. Similarly, an artist, song, video, or album may be moved up within the playlist, responsive to the user having indicated a positive preference for the media. Artists, songs, videos or albums may also be added to the playlist responsive to the user having indicated a positive preference, and the media being similar to or compatible with the artist seed or media within the playlist. Thus, a second user's preferences may expand the playlist while still maintaining compatibility with the first user's seed and preferences.

The media provider may filter and reorder the playlist for a station, room, or group by utilizing user data, preferences, social network metadata, and explicit ratings of all users in the room. The media provider also may apply one or more business rules to a playlist, based on license requirements or other rules, such as removing items of media selected more than a predetermined number of times within a time period (e.g. twice per hour, or four times per day).

The media provider may merge or sum preferences of users in the group, such as identifying each artist that a user has indicated a preference for (e.g. a Facebook “like”) and creating a tally of the number of users per artist that have made the indication. Such user information may be stored as tuples identifying the user, artist, and positive or negative preference. Similarly, the media provider may identify artists that users implicitly prefer, based on their explicit preferences for items of media by the artist. For example, if a user rates an item of media by an artist positively, the media provider may increment a rating value in a tuple of the user, artist, and rating value. Conversely, if the user rates the item of media negatively, the media provider may decrement the rating value. Such ratings may be stored as tuples, data fields, strings, counters, or via other data formats. These implicit ratings for each artist by each user may be summed, and may further be summed with the tally of users explicitly indicating a preference for an artist to generate an overall artist rating for the group or station, for each artist. The rating values for each artist may be compared to one or more thresholds. For example, artists with a group rating above a positive threshold may be identified as “loved artists,” while artists with a group rating below a negative threshold may be identified as “hated artists.” Although referred to as positive and negative, both thresholds may be positive numbers and thus “positive” may refer to the higher threshold. Given this group rating of artists and categorization, the media provider may modify the playlist by selecting the subset of items of media by “loved artists”, concatenated with items that are by artists with values between the positive and negative thresholds (i.e. neither “loved” nor “hated”) and may filter out items of media by “hated artists”. Thus, the resulting modified list may include items of media by artists that are not disliked by users, ordered by rating. In some embodiments, if the resulting number of items of media is less than a predetermined value, the media provider may not filter the results. This may prevent a playlist from being completely emptied due to incompatible user preferences in a group.

Similarly, the media provider may merge or sum preferences of users for individual items of media. For example, rather than explicit preferences for artists, the media provider may tally explicit preferences for items of media (such as a song for which a user has indicated a Facebook “like”). The media provider may tally such explicit preferences from social network sites, as well as explicit preferences or ratings within the media system (e.g. positive or negative ratings of songs or videos) to great a group rating value for each item of media. Such ratings may be compared to positive and negative thresholds, as above, to classify liked or disliked items of media. As above, items of media may be selected and concatenated to or filtered from the playlist based on their group ratings to generate a modified list of items of media that are liked or not disliked by users, in order of user ratings. As above, if the resulting number of items of media is less than a predetermined value, the media provider may not filter the results.

To select items of media, the media provider may iteratively select at random from the modified list, using a distribution that weights towards the beginning of the list, resulting in items that users prefer or that are by artists that users prefer being selected more often. Additionally, to ensure that at least one item of media by a seed artist is selected frequently, such an item of media by the seed artist or artists may be moved to the beginning of the list. Similarly, the media provider may select an item of media by an artist associated with the group or station. For example, if a station is generated based around an artist, an item of media by the artist may be moved to the top of the list to ensure that it's selected most often, regardless of other seeds and user preferences.

In a similar embodiment, an artist or item of media may be moved to the top of the list based on a request of a user joining the station or group. For example, a user may search for a station or group with a playlist or recommendation list that includes a specified artist, such as Van Halen, or a specified song, such as Jump. The media provider may return a list of stations that include said artist or item of media within their recommendation lists, which may include a station with the artist or item of media as a seed, but could also be other stations. For example, not only may the media provider respond to the search with identification of a station with a seed of Van Halen, it may also respond with identification of a station with a seed of Aerosmith, that happens to include Van Halen among its compatible or similar artists. If the user selects to join the Aerosmith station, the media provider may modify the playlist to move an item of media by Van Halen to the top of the priority list for selection, such that the likely first item of media that is selected will correspond to the user's search query (subject to the requirements of business rules or whether that item of media happened to have been recently selected prior to the user joining the station). The search query may be referred to as a “hint” indicating the user's preference, and the artist or item of media may be referred to as a “hinted artist” or “hinted item of media.” Accordingly, a modified playlist may include a hinted artist in a top position, a seed artist in a subsequent position, and liked or not disliked similar artists in subsequent positions.

Steps 1382-1386 may be repeated as additional users join the station or group. Metadata and preferences of current users in the group or station may be re-retrieved at step 1384, or may be stored or cached to reduce network or processing requirements. At step 1388, if a user leaves the station or group, steps 1384-1386 or step 1386 may be repeated with the preferences of the remaining users. Thus, as users join or leave, the playlist for the group or station may be dynamically adjusted to ensure that media selections are compatible with the preferences of all current users.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed:

1. A method for generating customized media playlists, comprising:
receiving, by a media server from a device of a first user, a request to generate a customized media playlist, the request including an identification of a first seed artist;
requesting, by the media server from a recommendation server, a first media list of media of the first seed artist;
requesting, by the media server from the recommendation server, a second media list of media compatible with the first seed artist;
requesting, by the media server from the recommendation server, a third media list of media compatible with one or more items of the first media list;
merging, by the media server, the first media list, second media list, and third media list to generate a fourth media list;
selecting, by the media server, an item of media from the fourth media list; and
transmitting, by the media server to the device of the first user, an identification of the selected item of media from the fourth media list.

2. The method of claim 1, further comprising modifying the fourth media list responsive to a positive or negative rating of an item of media in the fourth list by the first user.

3. The method of claim 1, wherein requesting the third media list further comprises requesting the third media list of media compatible with one or more items of the first media list and a second one or more items of media positively rated by the first user.

4. The method of claim 3, wherein the second one or more items of media positively rated by the first user comprise one or more items of a previously generated customized media playlist.

5. The method of claim 1, wherein requesting the third media list further comprises requesting the third media list of media compatible with one or more items of the first media list selected in order from the first media list.

6. The method of claim 1, wherein selecting the item of media from the fourth media list further comprises filtering the list to remove one or more recently selected items of media, responsive to one or more business rules.

7. The method of claim 1, wherein selecting an item of media from the fourth media list further comprises:
receiving, by the media server, an identification of a second user to receive the identification of the selected item of media from the fourth media list, and
modifying the fourth media list, by the media server, responsive to a combination of preferences of the first user and second user; and
further comprising transmitting an identification of the selected item of media from the fourth media list to a device of the second user.

8. The method of claim 7, wherein modifying the fourth media list comprises:
retrieving positive and negative ratings of artists by each of the first user and second user;
merging positive and negative ratings for each artist from the retrieved ratings to generate a combined score for each artist;
comparing each combined score to a threshold; and
modifying the fourth media list to remove items of media by artists with combined scores below the threshold.

9. The method of claim 7, wherein modifying the fourth media list comprises:
retrieving positive and negative ratings of items of media by each of the first user and second user;
merging positive and negative ratings for each item of media from the retrieved ratings to generate a combined score for each item of media;
comparing each combined score to a threshold; and
modifying the fourth media list to remove items of media with combined scores below the threshold.

10. The method of claim 1, wherein selecting an item of media from the fourth media list further comprises modifying the list to include in a first position an item of media by the first seed artist.

11. A system for generating customized media playlists, comprising:
a first device comprising a media server, in communication with a device of a first user, the first device configured for:
receiving, from the device of the first user, a request to generate a customized media playlist, the request including an identification of a first seed artist;
requesting, from a recommendation server, a first media list of media of the first seed artist;
requesting, from the recommendation server, a second media list of media compatible with the first seed artist;
requesting, from the recommendation server, a third media list of media compatible with one or more items of the first media list;
merging the first media list, second media list, and third media list to generate a fourth media list;
selecting an item of media from the fourth media list; and
transmitting, to the device of the first user, an identification of the selected item of media from the fourth media list.

12. The system of claim 11, wherein the first device is further configured for modifying the fourth media list responsive to a positive or negative rating of an item of media in the fourth list by the first user.

13. The system of claim 11, wherein the first device is further configured for requesting the third media list of media compatible with one or more items of the first media list and a second one or more items of media positively rated by the first user.

14. The system of claim 13, wherein the second one or more items of media positively rated by the first user comprise one or more items of a previously generated customized media playlist.

15. The system of claim 11, wherein the first device is further configured for requesting the third media list of media compatible with one or more items of the first media list selected in order from the first media list.

16. The system of claim 11, wherein the first device is further configured for filtering the list to remove one or more recently selected items of media, responsive to one or more business rules.

17. The system of claim 11, wherein the first device is further configured for:
receiving an identification of a second user to receive the identification of the selected item of media from the fourth media list;
modifying the fourth media list, responsive to a combination of preferences of the first user and second user; and
transmitting an identification of the selected item of media from the fourth media list to a device of the second user.

18. The system of claim 17, wherein the first device is further configured for:
retrieving positive and negative ratings of artists by each of the first user and second user;
merging positive and negative ratings for each artist from the retrieved ratings to generate a combined score for each artist;
comparing each combined score to a threshold; and
modifying the fourth media list to remove items of media by artists with combined scores below the threshold.

19. The system of claim 17, wherein the first device is further configured for:
retrieving positive and negative ratings of items of media by each of the first user and second user;
merging positive and negative ratings for each item of media from the retrieved ratings to generate a combined score for each item of media;
comparing each combined score to a threshold; and
modifying the fourth media list to remove items of media with combined scores below the threshold.

20. The system of claim 11, wherein the first device is further configured for modifying the list to include in a first position an item of media by the first seed artist.
